SEQUENCE LISTING (29 sequences)

SEQ ID NO: 1 - protein, 269 aa, Homo sapiens [sequence omitted]

SEQ ID NO: 2 - protein, 120 aa, Mus musculus
EVQLQQSGPELVKPGASVKISCKASGYTFTDYYMNWVKQSHGKSLEWIGGINPNNGGTSYNQKFKGKATLTVDKSSSTAYMELRSLTSEDSAVYYCARNDGYRGYAMDYWGQGTSVTVSS

SEQ ID NO: 3 - protein, 112 aa, Mus musculus
DIVMSQSPSSLAVSVGEKVTMSCKSSQSLLYSSNQKNYLAWYQQKPGQSPKLLIYWASTRESGVPDRFTGSGSGTDFTLTISSVKAEDLAVYYCQQYYSYPTFGAGTKLELK

SEQ ID NO: 4 - protein, 116 aa, Homo sapiens
VQSGAEVKKPGSSVKVSCKASGGTFSSYAISWVRQAPGQGLEWMGRIIPILGIANYAQKFQGRVTITADKSTSTAYMELSSLRSEDTAVYYCASSNWGPYWYFDLWGRGTLVTVSS

SEQ ID NO: 5 - protein, 121 aa, Homo sapiens
MVLQTQVFISLLLWISGAYGDIVMTQSPDSLAVSLGERATINCKSSQSVLYSSNNKNYLAWYQQKPGQPPKLLIYWASTRESGVPDRFSGSGSGTDFTLTISSLQAEDVAVYYCQQYYSTP

SEQ ID NO: 6 - protein, 120 aa, Artificial Sequence
  Heavy chain variable region scaffold with non-human SDRU residue substitutions
QVQLVQSGAEVKKPGSSVKVSCKASGYTFTDYYMNWVRQAPGQGLEWMGGINPNNGGTSYNQKFQGRVTITADESTSTAYMELSSLRSEDTAVYYCARNDGYRGYAMDYWGQGTLVTVSS

SEQ ID NO: 7 - protein, 112 aa, Artificial Sequence
  Light chain variable region scaffold with non-human SDRU residue substitutions
DIVMTQSPDSLAVSLGERATINCKSSQSLLYYSSNKKNYAWWYQQKPGQPPKLLIYWASTRESGVPDRFSGSGSGTDFTLTISSLQAEDVAYYCQQYYSYPTFGQGTKLELK

SEQ ID NO: 8 - protein, 120 aa, Artificial Sequence
  unknown (26)(27)(28)(29)(34)(51)(56)(58)(60)(61)(62): Heavy chain variable region sequences with non-human SDRU residue substitutions and random variegation of ADR residues wherein Xaa represents any one of the naturally occurring amino acids
QVQLVQSGAEVKKPGSSVKVSCKASXXXXTDYYXNWVRQAPGQGLEWMGGXNPNNXGXSXXXKFQGRVTITADESTSTAYMELSSLRSEDTAVYYCARNDGYRGYAMDYWGQGTLVTVSS

SEQ ID NO: 9 - protein, 120 aa, Artificial Sequence
  Affinity-matured heavy chain variable domain of anti-CD147 antibody
QVQLVQSGAEVKKPGSSVKVSCKASPRRNTDYYLNWVRQAPGQGLEWMGGVNPNNGGVSVGRKFQGRVTITADESTSTAYMELSSLRSEDTAVYYCARNDGYRGYAMDYWGQGTLVTVSS

SEQ ID NO: 10 - protein, 119 aa, Artificial Sequence
  Affinity-matured heavy chain variable domain of anti-CD147 antibody
QVQLVQSGAEVKKPGSSVKVSCKASTVSTDYYINWVRQAPGQGLEWMGSVNPNNRGSSVDSKFQGRVTITADESTSTAYMELSSLRSEDTAVYYCARNDGYRGYAMDYWGQGTLVTVSS

SEQ ID NO: 11 - protein, 120 aa, Artificial Sequence
  Affinity-matured heavy chain variable domain of anti-CD147 antibody
QVQLVQSGAEVKKPGSSVKVSCKASQPRPTDYYLNWVRQAPGQGLEWMGGINPNSGGVSVHQKFQGRVTITADESTSTAYMELSSLRSEDTAVYYCARNDGYRGYAMDYWGQGTLVTVSS

SEQ ID NO: 12 - protein, 120 aa, Artificial Sequence
  Affinity-matured heavy chain variable domain of anti-CD147 antibody
QVQLVQSGAEVKKPGSSVKVSCKASQTLRTDYYINWVRQAPGQGLEWMGGVNPNNGGSSSGLKFQGRVTITADESTSTAYMELSSLRSEDTAVYYCARNDGYRGYAMDYWGQGTLVTVSS

SEQ ID NO: 13 - protein, 119 aa, Artificial Sequence
  Affinity-matured heavy chain variable domain of anti-CD147 antibody
QVQLVQSGAEVKKPGSSVNVSCKASSHTTDYYLNWVRQAPGQGLEWMGGVNPNNGGASTGAKFQGRVTITADESTSTAYMELSSLRSEDTAVYYCARNDGYRGYAMDYWGQGTLVTVSS

SEQ ID NO: 14 - protein, 120 aa, Artificial Sequence
  Affinity-matured heavy chain variable domain of anti-CD147 antibody
QVQLVQSGAEVKKPGSSVKVSCKASMSSETDYYINWVRQAPGQGLEWMGGVNPNNNGTSYGYKFQGRVTITADESTSTAYMELSSLRSEDTAVYYCARNDGYRGYAMDYWGQGTLVTVSS

SEQ ID NO: 15 - protein, 210 aa, Mus musculus
MAAALLLALAFTLLSGQGACAAAGTIQTSVQEVNSKTQLTCSLNSSGVDIVGHRWMRGGKVLQEDTLPDLHTKYIVDADDRSGEYSCIFLPEPVGRSEINVEGPPRIKVGKKSEHSSEGELAKLVCKSDASYPPITDWFWFKTSDTGEEEAITNSTEANGKYVVVSTPEKSQLTISNLDVNVDPGTYVCNATNAQGTTRETISLRVRSRM

SEQ ID NO: 16 - protein, 105 aa, Artificial Sequence
  Human CD147 His-tagged N-terminal domain with substitutions with mouse residues
AAGTVQTTVQDLNSKTQLTCSLNDSATEVTGHRWLKGGVVLKEDALPGQKTEFKVDSDDQWGEYSCVFLPEPMGTANIQLHGPPRVKAVKSSEHINGGSHHHHHH

SEQ ID NO: 17 - protein, 105 aa, Artificial Sequence
  Human CD147 His-tagged N-terminal domain with substitutions with mouse residues
AAGTVFTTVEDLGSKILLTCSLNSSAVEVVGHRWLKGGKVLQEDALPGQKTEFKVDSDDQWGEYSCVFLPEPMGTANIQLHGPPRVKAVKSSEHINGGSHHHHHH

SEQ ID NO: 18 - protein, 105 aa, Artificial Sequence
  Human CD147 His-tagged N-terminal domain with substitutions with mouse residues
AAGTVFTTVEDLGSKILLTCSLNDSATEVTGHRWLKGGVVLKEDTLPDLHTKFIVDSDDRSGEYSCVFLPEPMGTANIQLHGPPRVKAVKSSEHINGGSHHHHHH

SEQ ID NO: 19 - protein, 105 aa, Artificial Sequence
  Human CD147 His-tagged N-terminal domain with substitutions with mouse residues
AAGTVFTTVEDLGSKILLTCSLNDSATEVTGHRWLKGGVVLKEDALPGQKTEFKVDSDDQWGEYSCVFLPEPMGRAEIQLEGPPRVKAVKSSEHINGGSHHHHHH

SEQ ID NO: 20 - protein, 121 aa, Artificial Sequence
  Human-adapted anti-IL-13 antibody heavy chain variable region
QVTLKESGPVLVKPTETLTLTCTVSGFSLSTYGMGVGWIRQPPGKALEWLAHIWWDDVKRYNPALKSRLTISKDTSKSQVVLTMTNMDPVDTATYYCARMGSDYDVWFDYWGQGTLVTVSS

SEQ ID NO: 21 - protein, 107 aa, Artificial Sequence
  Human-adapted anti-IL-13 antibody light chain variable region
EIVLTQSPATLSLSPGERATLSCRASKSISKYLAWYQQKPGQAPRLLIYSGSTLQSGIPARFSGSGSGTDFTLTISSLEPEDFAVYYCQQHNEYPYTFGQGTKLEIK

SEQ ID NO: 22 - protein, 146 aa, Homo sapiens
MHPLLNPLLLALGLMALLLTTVIALTCLGGFASPGPVPPSTALRELIEELVNITQNQKAPLCNGSMVWSINLTAGMYCAALESLINVSGCSAIEKTQRMLSGFCPHKVSAGQFSSLHVRDTKIEVAQFVKDLLLHLKKLFREGQFN

SEQ ID NO: 23 - protein, 117 aa, Artificial Sequence
  Affinity-matured anti-Il-17 antibody heavy chain variable region
QVQLVQSGAEVKKPGASVKVSCKASGYTFTDYAMHWVRQATGQGLEWMGVISTYSGDARFNQKFTGRVTMTRNTSISTAYMELSSLRSEDTAVYYCAREVRRSMDYWGQGTTVTVSS

SEQ ID NO: 24 - protein, 107 aa, Artificial Sequence
  Affinity-matured anti-Il-17 antibody light chain variable region
EIVLTQSPGTLSLSPGERATLSCKASQDVSTAVAWYQQKPGQAPRLLIYWASTRHTGIPDRFSGSGSGTDFTLTISRLEPEDFAVYYCQQHYSTPYTFGGGTKVEIK

SEQ ID NO: 25 - protein, 117 aa, Artificial Sequence; identical to SEQ ID NO: 23
  Affinity-matured anti-IL-17 antibody heavy chain variable region

SEQ ID NO: 26 - protein, 107 aa, Artificial Sequence
  Affinity-matured anti-IL-17 antibody light chain variable region
AIRMTQSPFSLSASVGDRVTITCKASQDVSTAVAWYQQKPAKAPKLFIYWASTRHTGVPSRFSGSGSGTDYTLTISSLQPEDFATYYCQQHYSTPYTFGGGTKVEIK

SEQ ID NO: 27 - protein, 116 aa, Artificial Sequence
  unsure (32)(50)(52)(54)(55)(57)(59): Library of anti-IL-17 antibody heavy chain variable regions with non-random SDRU residue substitutions wherein Xaa is represented by  one of the following amino acids Ile, Ala, Leu, Asn, Asp, Phe, Thr, Trp, Gly, Val, Pro,
QVQLVQSGAEVKKPGASVKVSCKASGYTFTDXAMHWVRQAPGQGLEWMGXIXTXXGXAXFNQKFTGRVTSTRDTSISTAYMELSRLRSDDTVVYYCAREVRRSMDYWGQGTTVTVS

SEQ ID NO: 28 - protein, 116 aa, Artificial Sequence
  unsure (32)(50)(52)(54)(55)(57)(59): Library of anti-IL-17 antibody heavy chain variable regions with non-random SDRU residue substitutions wherein Xaa is represented by  one of the following amino acids Ile, Ala, Leu, Asn, Asp, Phe, Thr, Trp, Gly, Val, Pro,
QVQLVQSGAEVKKPGASVKVSCKASGYTFTDXAMHWVRQAPGQGLEWMGXIXTXXGXAXYAQKFQGRVTMTRDTSTSTVYMELSSLRSEDTAVYYCAREVRRSMDYWGQGTTVTVS

SEQ ID NO: 29 - protein, 154 aa, Homo sapiens
MTPGKTSLVSLLLLLSLEAIVRAGITIPRNPGCPNSEDKNFPRTVMVNLNIHNRNTNTNPKRSSDYYNRSTSPWNLHRNEDPERYPSVIWEAQCRHLGCINADGNVDYHMNSVPIQQEILVLRREPPHCPSFRLEKILVSVGCTCVTPIVHHVQ

(19) United States
(12) Patent Application Publication
(10) Pub. No.: US 2010/0261620 A1
(43) Pub. Date: Oct. 14, 2010

(54) Methods of Humanizing and Affinity-Maturing Antibodies

(76) Inventors: Juan Carlos Almagro, Radnor, PA (US); Ramachandra Reddy, Radnor, PA (US); Johan Fransson, San Diego, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/578,803

(22) Filed: Oct. 14, 2009

Related U.S. Application Data
(60) Provisional application No. 61/105,168, filed on Oct. 14, 2008.

(51) Int. Cl. C40B 50/06

(52) U.S. Cl. 506/26

(57) ABSTRACT

Methods of humanizing and affinity-maturing antibodies are disclosed.

### CROSS REFERENCE TO RELATED APPLICATIONS

This application claims priority to U.S. Provisional Application Ser. No. 61/105,168, filed 14 Oct. 2008, the entire contents of which is incorporated herein by reference in its entirety.

### FIELD OF THE INVENTION

The invention relates to methods of humanizing and affinity-maturing antibodies.

### BACKGROUND OF THE INVENTION

More than 20 antibodies have been approved by the Food and Drug Administration (FDA) for therapeutic applications in humans and a similar number is in the late phase of clinical trials (Almagro and Strohl, Antibody Engineering: Humanization, Affinity Maturation, and Selection Techniques, In: Antibodies from bench to clinic, John Wiley & Sons, 2009). All antibody therapeutics so far described require large amounts and multiple doses and hence, immunogenicity is a critical concern when developing an antibody-based drug (Schellekens et al., Handbook of therapeutic antibodies. Ed: Dubel, Wiley-VCH, Weinheim, 2007). In vitro discovery of human antibodies via enrichment technologies such as phage display (Hoogenboom, Nat. Biotechnol. 23:1105-16, 2005) or immunization of transgenic mice bearing the human antibody gene repertoire (Bruggermann et al., In: Handbook of therapeutic antibodies. Ed: Dubel, Wiley-VCH, Weinheim, 2007) have provided powerful means to generate human antibodies. Humanization methods have been diversified during the last decade and the number of humanized antibodies has shown a continuous steady growth (Almagro and Fransson, Front. Bioscience 13:1619-33, 2008).

Antibody humanization methods are designed to produce a molecule with minimal immunogenicity when applied to humans, while retaining the specificity and affinity of the parental non-human antibody. Humanization began with chimerization (Morrison et al., Proc. Natl. Acad. Sci. USA 81:6851-5, 1984) in which the variable (V) domains of murine antibodies were combined with human constant (C) domains to generate molecules with ˜70% of human content. Chimeric antibodies successfully retained the mouse parent antibody specificity and diminished its immunogenicity; however they still elicited a human anti-chimeric antibody (HACA) response (Hwang and Foote, Methods 36:3-10, 2005).

Improved methods to minimize the use of non-human sequences in human antibodies include Complementarity Determining Region (CDR) grafting (U.S. Pat. No. 5,225,539 to Winter). In some cases, substituting CDRs from rodent antibodies for the human CDRs in human frameworks was sufficient to transfer antigen binding affinity (Jones et al., Nature 321:522-5, 1986; Verhoyen et al., Science 239:1534-36, 1998), whereas in other cases it has been necessary to additionally replace one or several framework residues. For example, Queen (Queen et al., Proc. Natl. Acad. Sci. USA 86:10029-33, 1989) humanized the first FDA approved antibody for therapeutic use in the United States, Zenapax®. Zenapax® was generated by selecting the human framework regions (FRs) to maximize homology with the murine antibody. Guided by a computer model of the mouse antibody, several murine amino acids outside the CDRs were identified that interacted with the CDRs or antigen. These residues were back-mutated in the humanized antibody to improve affinity.

Foote and Winter (Foote and Winter, J. Mol. Biol. 224:487-99, 1992) estimated in further studies that 30 residues underlying the CDRs, 16 in VH and 14 in VL, are responsible for stabilizing the HV loop structure as well as modifying their positioning, thus fine-tuning the antibody affinity. This region was called the Vernier Zone (VZ) and the residues defining it Vernier Residues (VR). Back-mutations in VRs as well as in those residues involved in the VH:VL interface have been described (U.S. Pat. No. 6,639,055 to Carter and Presta) as a method to restore the affinity of a given antibody after CDR grafting.

Humanization methods based on different paradigms such as Resurfacing (Padlan et al., Mol. Immunol. 28:489-98, 1991), Superhumanization (Tan et al., J. Immunol. 169:1119-25, 2002) and Human String Content Optimization (Lazar et al., Mol. Immunol. 44:1986-98, 2007) have also been developed. As in CDR grafting, these methods rely on analyses of the antibody structure and sequence comparison of the non-human and human antibodies in order to evaluate the potential impact of the humanization process on the final product. These methods have in common the generation of a few humanized variants to be tested for binding or any other property of interest. If the designed variants prove to be unsatisfactory, a new cycle of design and binding assessment is initiated. Therefore, these methods can be classified as rational strategies to humanize antibodies.

Phage display and high-throughput screening (HTS) techniques emerged as efficient tools to explore combinatorial libraries of large numbers of antibody variants and select the variants of interest (McCafferty et al., Nature 348:552-5, 1990). These techniques have been applied to antibody humanization protocols stimulating the creation of methods that rest on selection rather than on the design cycle. One of these methods, called Guided Selection (Osbourn et al., Methods 36:61-8, 2005) produced the first human antibody approved by the FDA (Jespers et al., Biotechnology 12:899-903, 1994) Humira® (Adalimumab). Guided Selection and other humanization strategies relying on selection of large combinatorial libraries make few assumptions on the impact of mutations on the final humanized product and accordingly, these techniques can be called empirical methods to humanize antibodies.

Humanizing an antibody with retention of high affinity for antigen and other desired biological activities requires a balance between replacing the original non-human sequence to reduce immunogenicity and the need for the humanized molecule to retain sufficient antigen binding to be therapeutically useful. Thus, improved methods for humanizing and affinity-maturing antibodies are needed.

### SUMMARY OF THE INVENTION

One aspect of an invention is a method of humanizing an antibody, comprising the steps of:
obtaining an amino acid sequence of a non-human antibody variable region;
determining a first canonical structure class of the non-human antibody variable region;
obtaining a first library of amino acid sequences of human antibody variable regions encoded by germline genes;
selecting a group of amino acid sequences from the first library, comprising the steps of:
   determining a second canonical structure class and a SDRU rank score for each amino acid sequence in the first library; and identifying the group of amino acid sequences from the first library having the identical second canonical structure class with the first canonical structure class, and further having the highest SDRU rank score; and
substituting in the group of amino acid sequences selected above
SDRU residues with corresponding non-human SDRU residues to produce a humanized antibody.

Another aspect of the invention is a method of affinity-maturing an antibody, comprising the steps of:
obtaining an amino acid sequence of the antibody;
determining affinity determining residues (ADR) in the antibody;
generating a library of amino acid sequences of the antibody by variegating at least one ADR residue;
expressing the library in a host or translating the library in vitro; and
selecting from the library one or more antibodies having an improved affinity to an antigen.

Another aspect of the invention is a method of making an affinity matured antibody, comprising:
obtaining an amino acid sequence of the antibody;
determining specificity determining residue usage (SDRU) residues in the antibody;
generating a library of amino acid sequences of the antibody by variegating at least one SDRU residue;
expressing the library in a host or translating the library in vitro; and
selecting from the library one or more antibodies having an improved affinity to an antigen.

### BRIEF DESCRIPTION OF THE FIGURES

FIG. 1. Correspondence between the Kabat and Chothia numbering systems, CDRs, HVs, SDRU residues, ADRs and VRs for heavy chains. Black: denoted residue. For SDRU, threshold ≧0.3 Gray: SDRU residue, threshold <0.3. Light gray: not assigned.

FIG. 2. Correspondence between the Kabat and Chothia numbering systems, CDRs, HVs, SDRU residues, ADRs and VRs for light chains. Black: denoted residue. For SDRU, threshold ≧0.3 Gray: SDRU residue, threshold <0.3. Light gray: not assigned.

FIG. 3. Human germline IGVH gene repertoire and canonical structure classes.

FIG. 4. Human germline IGVκ gene repertoire and canonical structure classes.

FIG. 5. Human germline IGHJ and IGκJ repertoire.

FIG. 6. Anti-CD147 antibody 4A5 heavy and light chain amino acid sequences. CDRs (Kabat), HV loops (Chothia) and SDRU residues (pSDRU) are indicated.

FIG. 7. SDRU rank scores for potential human scaffolds for A45. For VH, only the three genes with the highest score are shown.

FIG. 8. ADR library design. SDRU residues are marked with asterisks and ADR positions are represented with “X”. Substituted SDRU residues are underlined.

FIG. 9. VH sequence variants selected after three rounds of panning with human CD147 His-tagged N-terminal domain.

FIG. 10. Logo diagram of amino acid representation at ADR positions in the VH variants. Each column in the logo plot represents the amino acid frequencies as a stack of letters, where the height of each letter is proportional to the observed frequency of each amino acid.

FIG. 11. Anti-IL-17 antibody IL-17M70 and IL-17M82 heavy and light chain amino acid sequences. CDRs (Kabat), HV loops (Chothia) and SDRU residues (pSDRU) are indicated.

FIG. 12. IL-17M70 and IL-17M82 variant VL and VH amino acid sequences selected after three rounds of panning with human IL-17 K3R/K74Q/A136Q variant. A) IL-17M70 heavy chain B) IL-17M70 light chain C) IL-17M82 heavy chain, D) IL-17M82 light chain variant sequences.

### DETAILED DESCRIPTION OF THE INVENTION

All publications, including but not limited to patents and patent applications, cited in this specification are herein incorporated by reference as though fully set forth.

As used herein and in the claims, the singular forms “a,” “and,” and “the” include plural reference unless the context clearly dictates otherwise. Thus, for example, reference to “a polypeptide” is a reference to one or more polypeptides and includes equivalents thereof known to those skilled in the art.

Unless defined otherwise, all technical and scientific terms used herein have the same meaning as commonly understood by one of ordinary skill in the art to which an invention belongs. Although any compositions and methods similar or equivalent to those described herein can be used in the practice or testing of the invention, exemplary compositions and methods are described herein.

The term “antibodies” as used herein is meant in a broad sense and includes immunoglobulin or antibody molecules including polyclonal and monoclonal antibodies, non-human such as murine, human, human-adapted, humanized and chimeric monoclonal antibodies and antibody fragments. An antibody includes whole antibodies and any antigen binding fragment or a single chain thereof. A naturally occurring antibody comprises four polypeptide chains, two identical heavy chains and two identical light chains. Each heavy chain has at one end a variable domain (VH) followed by a number of constant domains (CH). Each light chain has a variable domain (VL) at one end and a constant domain (CL) at its other end; the constant domain of the light chain is aligned with the first constant domain of the heavy chain and the light chain variable domain is aligned with the variable domain of the heavy chain. Antibody light chains of any vertebrate species can be assigned to one of two clearly distinct types, namely kappa (κ) and lambda (λ), based on the amino acid sequences of their constant domains.

Immunoglobulins can be assigned to five major classes, namely IgG, IgM, IgD, IgA, and IgE, depending on the heavy chain constant domain amino acid sequences. IgA and IgG are further sub-classified as the isotypes IgA1, IgA2, IgG1, IgG2, IgG3, and IgG4.

“Antibody fragments” as used herein means a portion of an intact antibody, generally the antigen binding or variable region of the intact antibody. Examples of antibody fragments include Fab, Fab′, F(ab′)₂, and Fv fragments, diabodies, single chain antibody molecules and multispecific antibodies formed from at least two intact antibodies.

An “antibody variable region” as used herein refers to portions of the light and heavy chains of antibody molecules that include amino acid sequences of antigen-binding sites (for example CDR1, CDR2, CDR3), and framework regions (FRs, i.e. FR1, FR2, FR3, FR4). The light chain variable region (VL) is encoded by antibody V-, and J-segment genes, and the heavy chain variable region (VH) is encoded by antibody V-, D-, and J-segment genes. Genomic organization of the human heavy and light chain gene loci, antibody gene structures and gene rearrangements are well known.

“Humanized antibody” is an antibody containing one or more amino acids of an antigen-binding site from a non-human species and framework sequences of human origin. Constant regions may be present, and can be derived from human sequences, for example human germline sequences or from naturally occurring antibodies. Humanized antibodies can have one or more amino acids of the framework region amino acids from a non-human species, for example to improve affinity or specificity. The humanized antibody may comprise sequences from more than one class of isotype, and selecting particular constant domains to optimize desired effector functions for example cytotoxic activity is within the ordinary skill in the art.

The term “full-length antibody”, as used herein refers to an antibody in its substantially intact form including at least 2 heavy and 2 light chains. The term particularly refers to an antibody with heavy chains that contain a Fc region. A full-length antibody can be non-human, human, humanized and/or affinity matured.

An “affinity-matured antibody” as used herein is an antibody with one or more substitutions in a variable region, which results in an improved affinity of the antibody for an antigen, compared to a parent antibody which does not possess those substitutions. Exemplary affinity-matured antibody has substitutions in at least one ADR residue.

“Affinity” as used herein refers to the strength of interaction between an antibody and a ligand. The affinity of an antibody is represented by the dissociation constant (Kd). Typically, the antibody binds with a dissociation constant (K_{D}) of 10⁻⁷ M or less, 10⁻⁸ M or less, 10⁻⁹ M or less or 10⁻¹⁰ M or less, for a predetermined antigen. “Improved affinity” as used herein refers to at least two-fold reduction in a Kd of the affinity-matured antibody compared to its parent. The affinity of the antibody can be determined using well known methods, for example Competitive binding ELISA assay, Surface Plasmon Resonance using BIOAcore™ or KinExA.

An immunoglobulin light (VL) or heavy chain (VH) variable region consists of a “framework” region interrupted by three “antigen-binding sites”. The antigen-binding sites are delineated using various terms as follows:

(i) “Complementarity Determining Regions”, “CDR”, within antibody variable sequences as defined by Kabat (Kabat et al., Sequences of Immunological Interest, 5^{th} Ed. Public Health Service, NIH, Bethesda, Md., 1991) and are based on sequence variability. There are three CDRs in each of the variable heavy and variable light sequences designated CDR1, CDR2 and CDR3, for each of the variable regions.

(ii) “Hypervariable region”, “HVR”, or “HV” refers to the regions of an antibody variable domain which are hypervariable in structure as defined by Chothia and Lesk (Chothia and Lesk, Mol. Biol. 196:901-917, 1987). Generally, the antigen-binding site has six hypervariable regions, three in VH (H1, H2, H3) and three in VL (L1, L2, L3).

(iii) “IMGT-CDR” proposed by Lefranc (Lefranc et al., Dev. Comparat. Immunol. 27:55-77, 2003) based on the comparison of V domains from immunoglobulins and T-cell receptors. The International ImMunoGeneTics (IMGT) database (http:_//www_imgt_org) provides a standardized numbering and definition of these regions. The correspondence between CDRs, HVs and IMGT delineations is described in Lefranc et al., Dev. Comparat. Immunol. 27:55-77, 2003.

(iv) Another definition of the regions that form the antigen-binding site is “Specificity Determining Residues”, “SDR”, as described by Padlan are defined by a combination of sequence analysis and available crystal structure information (Padlan et al., FASEB J., 9, 133-9, 1995).

(v) The antigen-binding site can also be delineated based on Specificity Determining Residue Usage (SDRU), a precise measure of a number and distribution of residues in contact for different types of antigens, for example proteins, peptides and haptens (Almagro, Mol. Recognit. 17:132-43, 2004). To determine the SDRU, a score of antigen-antibody contacts can be calculated using formula:

SDRU=1−[(cm−ci)/cm];

where cm is the maximum number of contacts in VL or VH and ci is the frequency of contacts per position. SDRU residues are numbered according to Chothia and Lesk (Chothia and Lesk, Mol. Biol. 196:901-917, 1987). SDRU can range from 0-1. A SDRU value ≧0.7 corresponds to a SDR that is found to be in contact in more than 67% of complexes, and is defined as of high usage. SDRU value <0.3 corresponds to a SDR that is found to be in contact in less than 33% of complexes, and is defined as of low usage. SDRU values between 0.3-0.7 are considered medium usage. A residue is a “SDRU residue” as used herein, when the SDRU score at that position is ≧0.3. For some applications, the “SDRU residue” may include residues having a SDRU score between 0-0.3 in order to increase the number of SDRU residues for analyses or substitutions. For example, example 1 below used the SDRU score of >0 to define SDRU residues for humanization in order to maximize the number of residue to be transferred from a non-human antibody to the human scaffold to retain specificity and affinity during the humanization process. SDRU score of >0.3 or >0.7 can be used for example to define SDRU residues to be variegated for affinity-maturation in order to increase the representation of the resulting libraries, especially when NNK codons are used.

“Canonical structures” are the HV loop structure types determined by the HV loop length and conserved residues in the HV and frameworks, and are shown for HV and HL in Tables 1 and 2, respectively (Al-Lazikani et al., J. Mol. Biol., 273:927-48, 1997).

“Canonical structure class” is the combined canonical structures for heavy chain H1 and H2 or light chain L1, L2 and L3.

“Chothia residues” are the antibody VL and VH residues numbered according to Al-Lazikani (Al-Lazikani et al., J. Mol. Biol., 273, 927-48, 1997).

“Corresponding SDRU residues” as used herein refers to the SDRU residues that correspond in position between two different variable region sequences, for example between a human and a non-human variable region sequences.

“SDRU rank score” as used herein refers to a homology rank score for a test sequence based on the number of identities and similarity between the corresponding SDRU residues in the parent sequence. For identical residues, a score value of 1 is assigned. For similar residues, a score value of 0.5 is assigned. For other residues, a score value of 0 is assigned. The resulting “SDRU rank score” is a sum of the individual rank scores. Five groups of similar residues for assigning a score value of 0.5 are defined as: (i) Polar amino acids: S, T, N, Q, (ii) non-polar amino acids A, V, I, L, M; (iii) aromatic amino acids F, W, Y; (iv) acidic amino acids D, E; and (v) basic amino acids H, K, R. Exemplary test sequence is a human antibody heavy chain variable region amino acid sequence, and an exemplary parent sequence is a non-human antibody heavy chain variable region amino acid sequence.

TABLE 1
Canonical structure types for VH.

| HV | | Pattern | | | | | | | | | | |
|---|---|---|---|---|---|---|---|---|---|---|---|---|
| Region | | Amino acid position | | | | | | | | | | |
| H1 | Type | 24 | 26 | 27 | 28 | 29 | 30 | 31 | 31a | 31b | 32 | 34 |
| | Type 1 | | | | | | | | | | | |
| | | T | G | F | X | F | X | X | — | — | X | M |
| | | A | | Y | | L | | | | | | I |
| | | V | | T | | I | | | | | | V |
| | | G | | G | | V | | | | | | L |
| | | S | | S | | | | | | | | T |
| | | | | D | | | | | | | | Y |
| | | | | | | | | | | | | W |
| | Type 2 | | | | | | | | | | | |
| | | V | G | G | X | I | X | X | X | — | X | W |
| | | F | | F | | L | | | | | | V |
| | | | | Y | | | | | | | | |
| | Type 3 | | | | | | | | | | | |
| | | V | G | F | X | I | X | X | X | X | X | W |
| | | F | | G | | L | | | | | | V |
| | | G | | D | | V | | | | | | |
| | | I | | | | | | | | | | |

| HV | | Pattern | | | | | | | | |
|---|---|---|---|---|---|---|---|---|---|---|
| Region | | Amino acid position | | | | | | | | |
| H2 | Type | 52 | 52a | 52b | 52c | 53 | 54 | 55 | 56 | 71 |
| | Type 1 | | | | | | | | | |
| | | X | — | — | — | X | X | G | X | R |
| | | | | | | | | D | | K |
| | | | | | | | | S | | V |
| | | | | | | | | | | I |
| | Type 2 | | | | | | | | | |
| | | X | P | — | — | C | C | G | X | A |
| | | | T | | | | | S | | L |
| | | | A | | | | | D | | T |
| | | | | | | | | | | V |
| | Type 3 | | | | | | | | | |
| | | X | D | — | — | X | G | G | X | R |
| | | | P | | | | N | S | | |
| | | | S | | | | D | | | |
| | | | N | | | | S | | | |
| | Type 4 | | | | | | | | | |
| | | X | X | X | X | X | K | Y | X | R |
| | | | | | | | S | | | |
| | | | | | | | N | | | |
| | | | | | | | G | | | |

TABLE 2

Canonical structure types for Vk.

| | |
|---|---|
| LV | Pattern |
| Region | Amino acid position |

| | | | | | | | | | | | | | | | | | | |
|---|---|---|---|---|---|---|---|---|---|---|---|---|---|---|---|---|---|---|
| L1 | Type | 2 | 25 | 26 | 27 | 28 | 29 | 30 | 31 | 31a | 31b | 31c | 31d | 31e | 31f | 32 | 33 | 71 |

| | | | | | | | | | | | | | | | | | |
|---|---|---|---|---|---|---|---|---|---|---|---|---|---|---|---|---|---|
| Type 1 | | | | | | | | | | | | | | | | | |
| | I | A | X | X | X | V | X | — | — | — | — | — | — | — | X | L | Y |
| | | | | | | I | | | | | | | | | | M | F |
| | | | | | | L | | | | | | | | | | | |
| Type 2 | | | | | | | | | | | | | | | | | |
| | I | A | X | X | X | V | X | X | — | — | — | — | — | — | X | L | Y |
| | | | | | | I | | | | | | | | | | V | F |
| | | | | | | L | | | | | | | | | | I | V |
| | | | | | | P | | | | | | | | | | A | |
| Type 3 | | | | | | | | | | | | | | | | | |
| | I | S | X | X | X | V | X | X | X | X | X | X | X | X | X | L | Y |
| | | | | | | I | | | | | | | | | | | F |
| | | | | | | L | | | | | | | | | | | |
| Type 4 | | | | | | | | | | | | | | | | | |
| | V | S | X | X | X | L | X | X | X | X | X | X | X | — | X | L | F |
| | I | P | | | | I | | | | | | | | | | F | |
| | L | | | | | | | | | | | | | | | | |
| Type 5 | | | | | | | | | | | | | | | | | |
| | I | A | X | X | X | V | X | X | X | X | X | X | — | — | X | L | Y |
| | | | | | | | | | | | | | | | | M | F |
| | | | | | | | | | | | | | | | | I | |
| Type 6 | | | | | | | | | | | | | | | | | |
| | N | A | X | X | X | V | X | X | X | — | — | — | — | — | X | L | Y |

| | | |
|---|---|---|
| | | Pattern |
| LV Region | Type | Amino acid position |

| | | | | | | |
|---|---|---|---|---|---|---|
| L2 | Type 1 | 48 | 50 | 51 | 52 | 64 |

| | | | | |
|---|---|---|---|---|
| I | X | X | X | G |
| V | | | | X |

| | |
|---|---|
| | Pattern |
| LV Region | Amino acid position |

| | | | | | | | | | |
|---|---|---|---|---|---|---|---|---|---|
| L3 | Type | 90 | 91 | 92 | 93 | 94 | 95 | 95a | 96 |

| | | | | | | | | |
|---|---|---|---|---|---|---|---|---|
| Type 1 | | | | | | | | |
| | Q | X | X | X | X | P | — | X |
| | N | | | | | | | |
| | H | | | | | | | |
| Type 2 | | | | | | | | |
| | Q | X | X | X | P | L | — | X |
| Type 3 | | | | | | | | |
| | Q | X | X | X | X | P | — | — |
| Type 4 | | | | | | | | |
| | Q | X | X | X | X | — | — | — |
| Type 5 | | | | | | | | |
| | Q | X | X | X | X | X | — | P |
| | S | | | | | | | N |
| | | | | | | | | S |

“Framework” or “framework sequence” are the remaining sequences of a variable region other than those defined to be antigen-binding site. Because the antigen-binding site can be defined by various delineations as described above, the exact amino acid sequence of a framework depends on delineation of the antigen-binding site.

“Affinity Determining Residues” (ADR) are defined as the non-SDRU residues residing within the CDRs, wherein the CDRs are delineated as follows: CDR-1 from VL encompasses residues 24-36, the CDR-2 from VL encompasses residues 46-56, CDR-3 from VL encompasses residues 89-98, CDR-1 from VH residues 27-37, CDR-2 from VH residues 47-61, and CDR-3 from VH residues 93-103 (Table 1). ADRs include residues in the vicinity of the SDRU residues. The ADRs may be buried in the V domains, may be important for the HV loop conformation, and responsible for modifying the structure and positioning of the HV loops. Because the SDRU residues may be delineated using various SDRU scores, the exact ADR residues within a variable region depends on delineation of the SDRU residues.

“Vernier Residues” (VRs) are the 30 residues residing in the framework of the antibody variable region identified to be responsible for stabilizing the HV loop structure as well as modifying their positioning (Foote and Winter, J. Mol. Biol., 224:487-99, 1992). In some instances VRs coincide with residues responsible for maintaining the canonical structures (Al-Lazikani et al., J. Mol. Biol., 273:927-48, 1997).

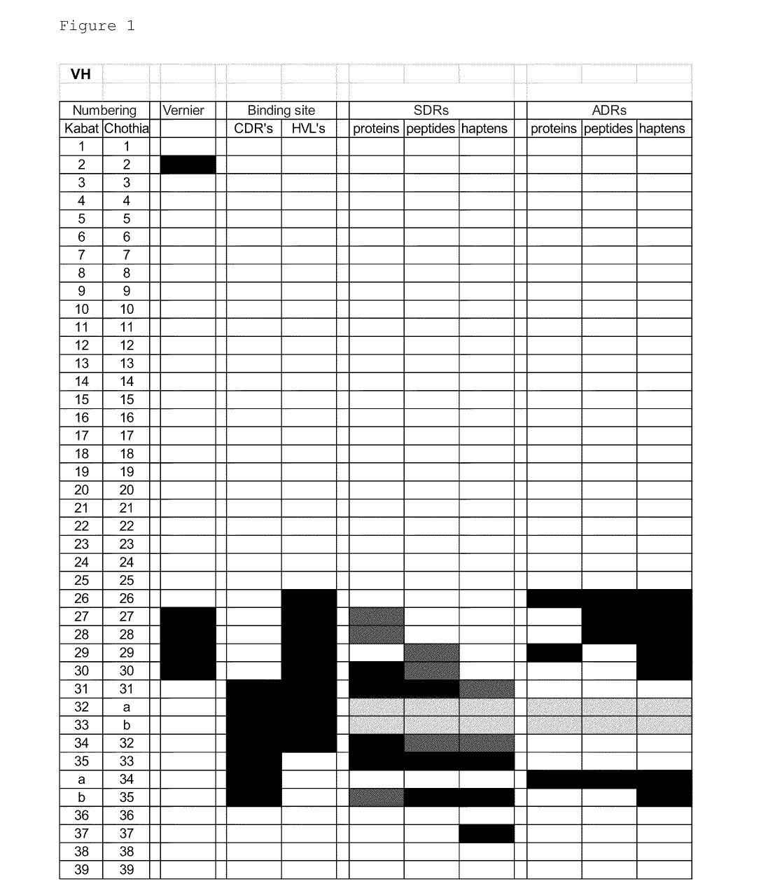

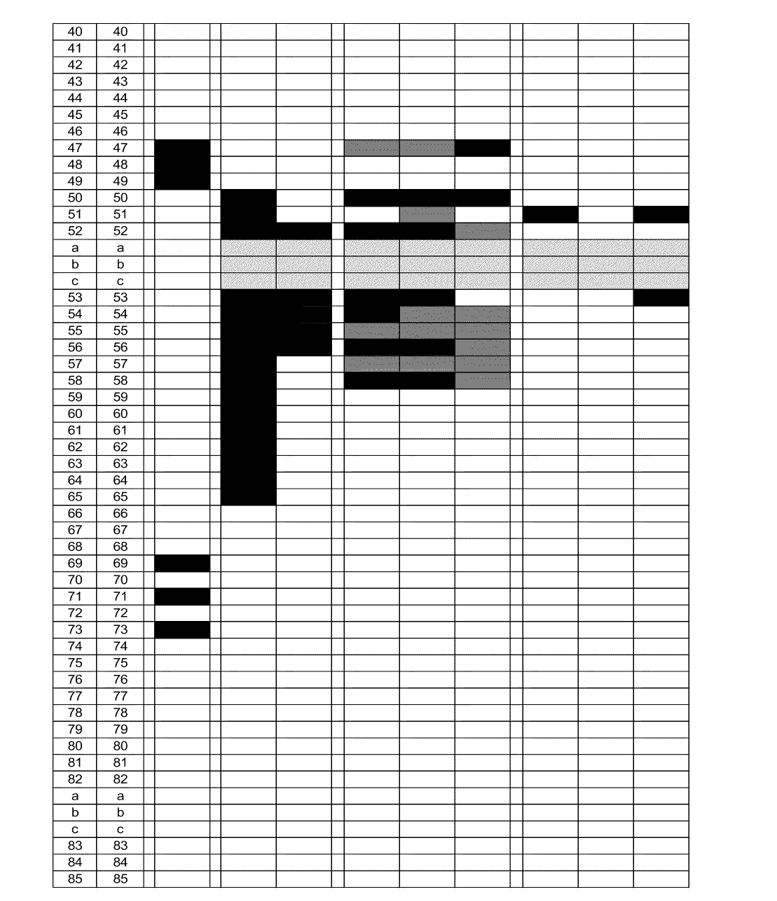

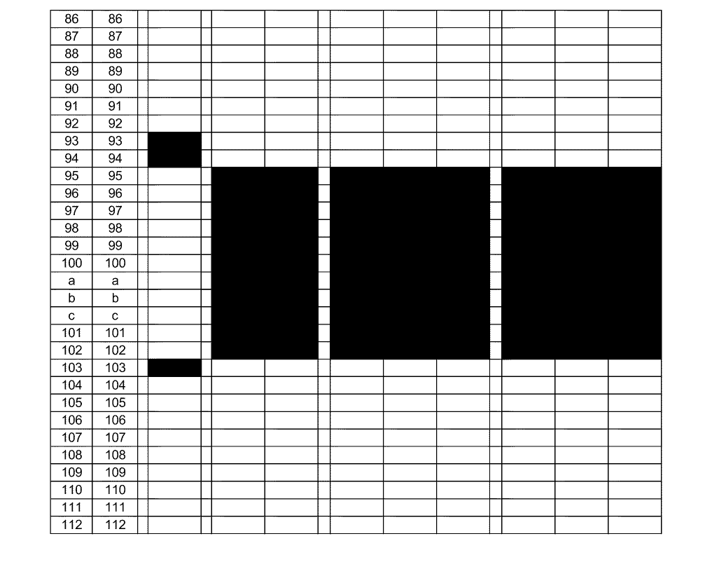

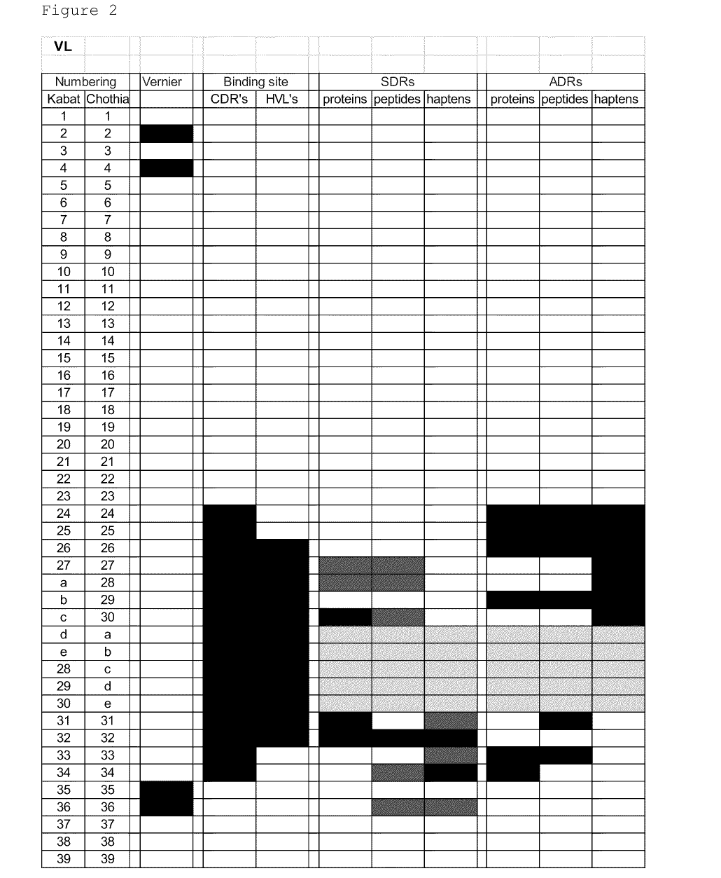

Correspondence between the most two used numbering systems, Kabat (Kabat et al., Sequences of Immunological Interest, 5^{th} Ed. Public Health Service, NIH, Bethesda, Md., 1991) and Chothia (Chothia and Lesk, Mol. Biol. 196:901-917, 1987) as well as CDRs, HVs, SDRU residues, ADRs and VRs is shown in FIGS. 1 and 2 for heavy and light chains, respectively. Residues marked in grey are not defined for SDRU and ADR. A residue with a SDRU score of ≧0.3 is shown in black, and a residue with a SDRU score of <0.3 is shown in gray in the figures.

The term “protein” as used herein means a molecule that comprises at least two amino acid residues linked by a peptide bond to form a polypeptide. Small proteins of less than 30 amino acids may be referred to as “peptides”. Proteins may also be referred as “polypeptides”.

“Fusion Protein” is a protein comprised of at least two polypeptides and a linking sequence to operatively link the two polypeptides into one continuous polypeptide. The two polypeptides linked in a fusion polypeptide are typically derived from two independent sources, and therefore a fusion polypeptide comprises two linked polypeptides not normally found linked in nature. The linking sequences are well known, and include for example an amide bond or a glycine-rich linker. Exemplary fusion proteins are VL and VH fusions with bacteriophage coat proteins, for example pIII, pVII, or pIX (Gao et al., Proc. Natl. Acad. Sci. USA, 96:6025-30, 1999). Fusion proteins are made using well known methods.

“Desired biological activity” of an antibody includes for example enhanced or modified binding, enhanced or modified affinity, on-rate, off-rate, specificity, half-life, reduced immunogeneicity, efficient expression and production from a variety of hosts, antibody stability, and good solution properties, or any other suitable characteristic.

“Germline genes” as used herein are immunoglobulin sequences encoded by non-lymphoid cells that have not undergone the maturation process that leads to genetic rearrangement and mutation for expression of a particular immunoglobulin.

“Pairing of antibody variable regions” as used herein refers to association of VH and VL in vivo to form a full length naturally occurring antibody. The human antibody germline gene repertoire consists of about 40 heavy chain, 35 kappa, and 30 lambda functional V genes. Instead of a random association of heavy and light chains encoded by specific V segment genes, a bias exists towards certain light and heavy chains occurring in natural antibodies in a non-random manner (de Wildt et al., J. Mol. Biol. 285: 895-901, 1999). When selecting heavy and light chain V-segment germline genes as framework donors for humanization, preference is given to those V genes that are paired in vivo.

The term “substituting” or “variegating” or “mutating” or “diversifying” can be used interchangeably and as used herein refers to altering one or more amino acids in a peptide or protein sequence to generate a variant of that sequence.

“Variant” as used herein refers to a polypeptide or polynucleotide that differs from a reference polypeptide or polynucleotide and may or may not have altered properties. A variant and reference polypeptide may differ in amino acid sequence by one or more modifications for example, substitutions, insertions or deletions.

“Library” as used herein refers to a collection of one or more variants.

“Scaffold” as used herein refers to amino acid sequences of light or heavy chain variable regions encoded by human germline genes. Thus, the scaffold encompasses both the framework and the antigen-binding site.

This invention describes methods of humanizing and affinity-maturing antibodies.

### Methods of Humanizing Antibodies

### Specificity Determining Residues Resurfacing (SDRR)

Specificity Determining Residues Resurfacing (SDRR) is a method to humanize antibodies. SDRR differs from published methods by (i) utilizing SDRU rank order to select a scaffold and (ii) transferring specificity of the non-human antibody into the selected scaffold by substituting SDRU residues.

In published humanization methods, specificity of the non-human antibody is transferred to human scaffolds by mutating CDRs (U.S. Pat. No. 5,225,539 to Winter; U.S. Pat. No. 6,881,557 to Foote) or SDRs (U.S. Pat. No. 6,818,749 to Kashmiri), with optionally back-mutating several framework residues important in retaining canonical structure (U.S. Pat. No. 5,693,761 to Queen) or positioning of the HV loops (U.S. Pat. No. 6,639,055 to Carter). The human scaffolds have been selected based on homology to germline genes (Gonzales et al., Mol. Immunol. 41:863-72, 2004), somatic or consensus immunoglobulin variable region genes, with possible further selection by evaluating CDR or canonical structure homologies (U.S. Pat. No. 6,881,557 to Foote). Correspondence between residues humanized with the methods described above is shown in FIGS. 1 and 2.

The benefit of SDRR over previous humanization methods is that a minimal number of non-human residues can be transferred into the selected scaffold due to precise definition of SDRU residues and the possibility of tailoring the humanization protocol to antibodies that recognize different types of generic ligands such as proteins, peptides or haptens, thus reducing potential immunogeneicity of the humanized antibody.

SDRU residues have been substituted to generate de novo libraries of antibodies, however, humanization or affinity-maturing with focused libraries has not been attempted (Persson et al., J. Mol. Biol. 357: 607-620, 2006; Cobaugh et al., J Mol. Biol. 378: 622-633, 2008).

One embodiment of the invention is a method of humanizing an antibody, comprising the steps of:
a. obtaining an amino acid sequence of a non-human antibody variable region;
b. determining a first canonical structure class of the non-human antibody variable region;
c. obtaining a first library of amino acid sequences of human antibody variable regions encoded by germline genes;
d. selecting a group of amino acid sequences from the first library, comprising the steps of:
   i. determining a second canonical structure class and a SDRU rank score for each amino acid sequence in the first library; and
   ii. identifying the group of amino acid sequences from the first library having the identical second canonical structure class with the first canonical structure class, and further having the highest SDRU rank score; and
e. substituting in the group of amino acid sequences selected in step d) SDRU residues with corresponding non-human SDRU residues to produce a humanized antibody.

The method of the embodiment above is herein named “SDRR”, “Specificity Determining Residue Resurfacing”.

An amino acid sequence of a non-human antibody heavy and light chain variable domains can be obtained by determining the sequence by well known methods, for example genomic or PCR-cloning followed by DNA sequencing. Non-human antibodies include antibodies from any species other than human, for example rodent, camel, or monkey antibodies.

In the methods of the invention, the human scaffold is selected from a library of amino acid sequences of human antibody variable regions encoded by germline genes based on canonical structure class identity and SDRU rank score to the non-human antibody. Germline V-segment genes are used to select FR1, FR2 and FR3, and the germline J-segment genes are used to select FR4.

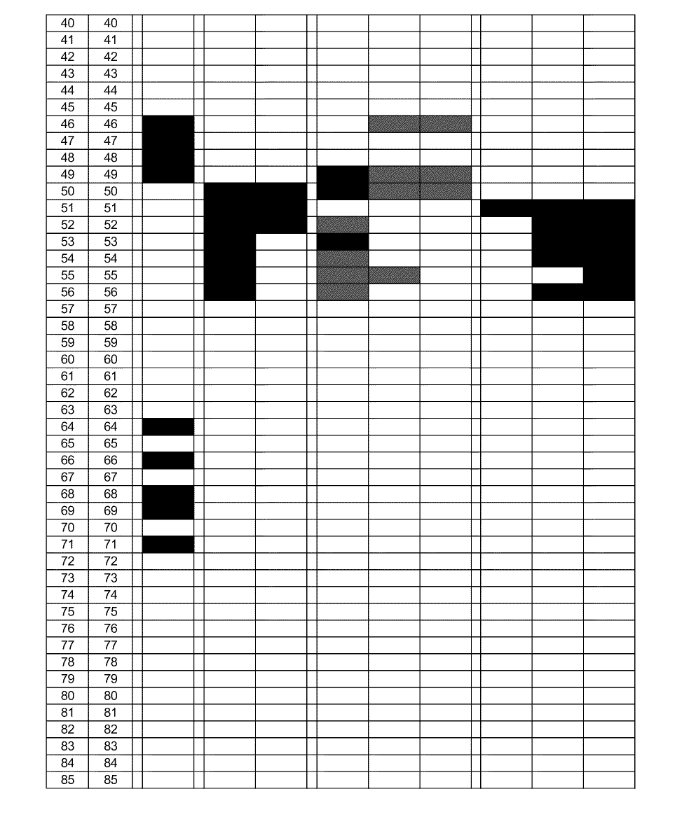

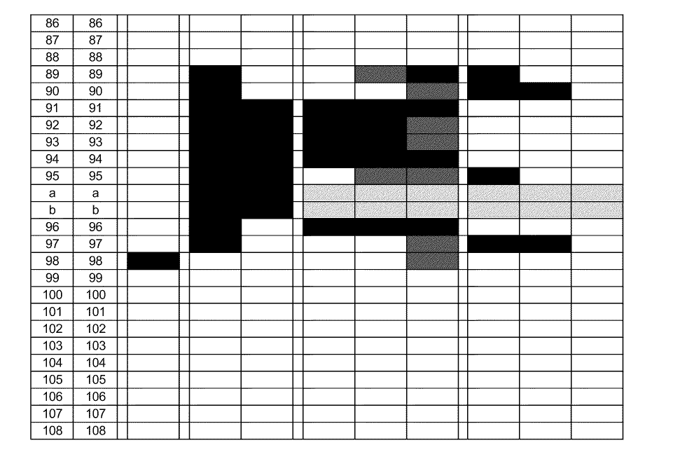

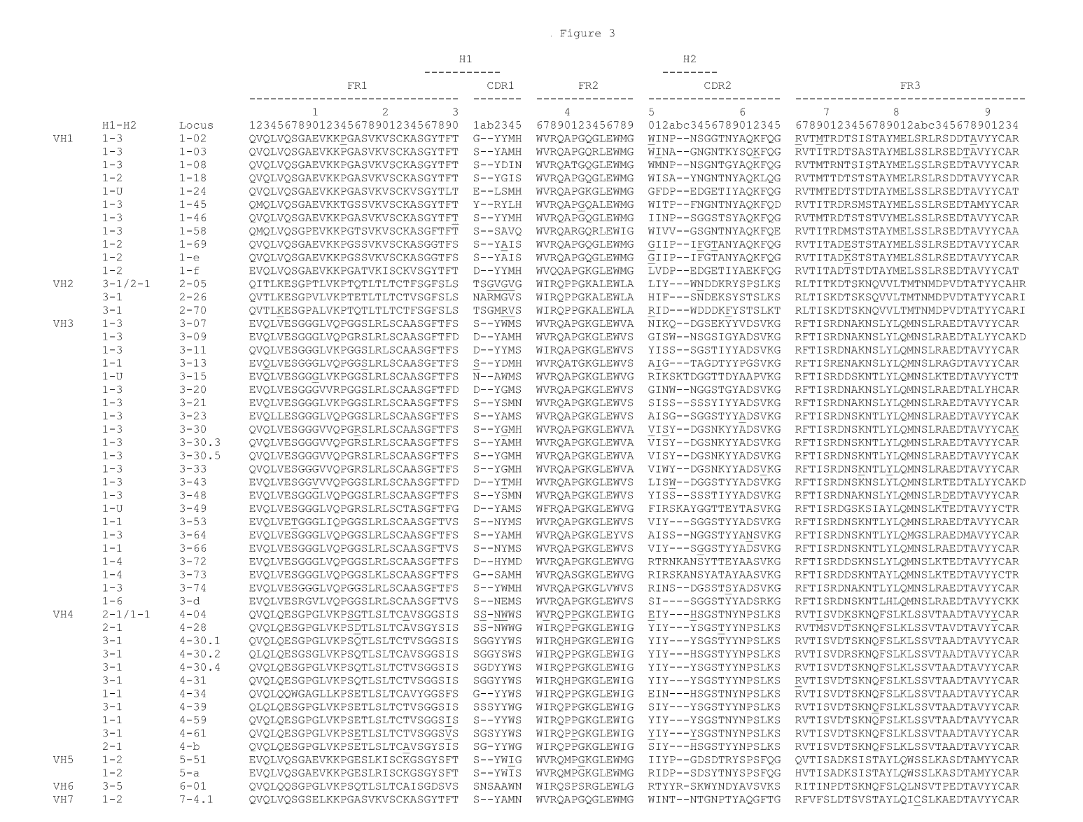

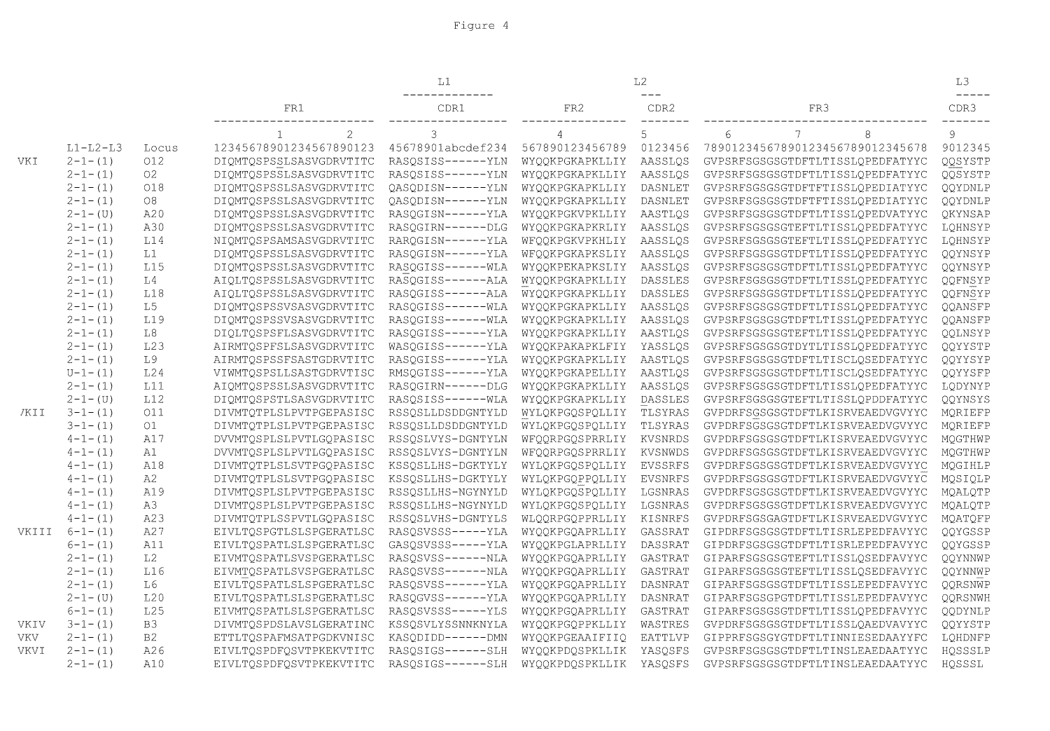

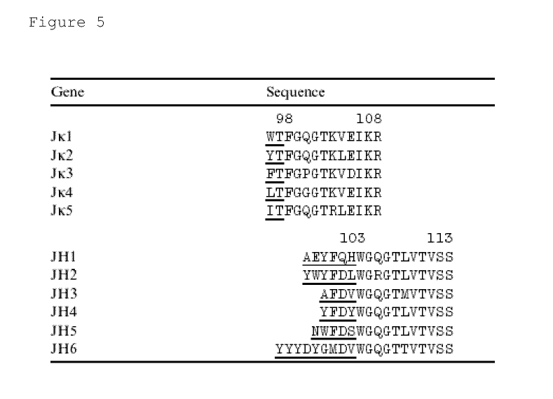

Germline gene sequences can be downloaded from the ImMunoGeneTics database (http_//www_imgt_org). FIGS. 3 and 4 list the human “01” germline IGVH and IGVκ genes compiled from IMGT as well as the canonical structure classes they encode. FIG. 5 shows the human sequences of the IGHJ and IGκJ J-segment genes. Human germline genes have increasingly been utilized as the source of human frameworks instead of consensus or mature sequences to avoid somatic mutations that could be immunogenic (Almagro and Fransson, Front. Biosci. 13:1619, 2008). In addition, germline genes could provide improved plasticity and flexibility to accommodate diverse antigen-binding sites with no or a few back-mutations into the FR to restore affinity of humanized antibody (Wedemayer et al., Science 276:1665-9, 1997; Zimmermann et al., Proc. Natl. Acad. Sci. USA 103:13722-7, 2006; Gonzales et al., Mol. Immunol. 41:863-72, 2004).

The canonical structure classes were determined according to the patterns described in Tables 1 and 2. Some antibodies from species other than human or some human antibodies that are products of the maturation of the immune response have canonical structure types not encoded in the human genome (Almagro et al., Mol. Immunol. 34:1199-1214, 1997; Almagro et al., Immunogenetics 47:355-63, 1998). For example, some murine germline genes encode type 1 and 5 at L1. These canonical structures are absent in human germline genes. In such cases, human germline V genes having similar canonical structures are considered for comparison. For example, where type 1 is found in a non-human antibody, human Vκ sequences with type 2 should be used for comparison. Where type 5 is found in a non-human antibody, human Vκ sequences with either type 3 or 4 should be utilized for comparison.

Specificity of the non-human antibody is transferred into the selected human scaffold by substituting the SDRU residues of the non-human antibody into the selected human scaffold. Typically all SDRU residues in a selected scaffold are substituted for non-human SDRU residues. Substituting SDRU residues can be done by well known methods, for example by PCR mutagenesis (U.S. Pat. No. 4,683,195 to Mullis). For example, 94L for CDR-L3, 31H, 33H and 35H for CDR-H1, 52H, 53H, 54H, 56H and 58H for CDR-H2, and residues 95H-102H for CDR-H3 in the non-human antibody can be substituted into the selected scaffold.

In another embodiment of the invention, the germline genes are selected from VH, Vκ, Vλ, JH, Jκ or Jλ sequences.

Another aspect of the invention is a further selection of the group of amino acid sequences from the first library by evaluating pairing of antibody variable regions as described above.

In another embodiment of the invention, a method of humanizing an antibody further comprises the steps of:
e-i: determining affinity determining residues (ADR) in the group of amino acid sequences selected in step d);
e-ii: generating a second library of amino acid sequences of human antibody variable regions by variegating at least one ADR residue;
e-iii: expressing the second library in a host or translating the second library in vitro; and
e-iv: selecting from the second library those variable regions having a desired biological activity.

In the methods of the invention, ADR variegation is designed to retain, restore or improve the affinity after selectivity of the non-human antibody is transferred into the selected scaffold by SDRU residue substitutions. The ADR residues are defined above and shown in FIGS. 1 and 2 for heavy and light chains, respectively. At least one, two, three or more ADRs may be variegated. ADRs residing in either light or heavy chain may be variegated. Alternatively, a defined subset of ADRs can be variegated. For example, Chothia residues 34H, 51H, and 55H are variegated, or Chothia residues 34H, 51H, 55H, 59H, 60H, and 61H are variegated. ADR variegation offers several benefits. For example, incompatibilities between non-human residues and human residues encircling them may cause an affinity loss in the resulting antibody. Differences between the structure of the non-human and human HV loops may account for different positioning of the residues defining the specificity of the antibody and thus affinity losses.

A library of amino acid sequences generated by variegating at least one ADR residue is “an ADR library” as used herein. An ADR library is for example a library of heavy or light chain variable region variants. An ADR library can be generated using well known methods. For example, ADR variants in the library having random substitutions can be generated using NNK codons, which encode all 20 naturally occurring amino acids. Alternatively, ADR variants with non-random substitutions can be generated using for example DVK codons, which encodes 11 amino acids (ACDEGKNRSYW) and one stop codon. Alternatively, Kunkel mutagenesis can be used to variegate ADRs (Kunkel et al., Methods Enzymol. 154:367-382, 1987).

Standard cloning techniques are used to clone the ADR libraries into a vector for expression. The ADR library may be expressed using known system, for example expressing the library as fusion proteins. Exemplary fusion proteins are ADR library variant fusions with a viral coat protein such as pIII, pVIII, pVI, pVII, and variants thereof. The fusion proteins can be displayed on the surface of any suitable phage. Methods for displaying fusion polypeptides comprising antibody fragments on the surface of a bacteriophage are well known (U.S. Pat. No. 6,969,108 to Griffith; U.S. Pat. No. 6,172,197 to McCafferty; U.S. Pat. No. 5,223,409 to Ladner; U.S. Pat. No. 6,582,915 to Griffiths; U.S. Pat. No. 6,472,147 to Janda, WO2009085462A1). ADR libraries can also be translated in vitro, for example using ribosome display (Hanes and Pluckthun, Proc. Natl. Acad. Scie. USA, 94:4937, 1997), mRNA display (Roberst and Szostak, Proc. Natl. Acad. Sci. USA, 94:12297, 1997), or other cell-free systems (U.S. Pat. No. 5,643,768 to Kawasaki). ADR library may be expressed and displayed in various formats, including Fab, Fab′, F(ab′)₂, scFv, or Fv. In the Example 1 of the invention, the ADR library was expressed as a fusion protein with bacteriophage coat protein pIX (WO2009085462A1 to Ping).

The resulting library can be screened for antibodies or antibody fragments of desired biological activity, for example reduced, enhanced or modify binding, affinity, on-rate, off-rate, or specificity, or any other suitable characteristic. For example, a humanized antibody of the invention may bind its antigen with a K_{d} less than or equal to about 10⁻⁷, 10⁻⁸, 10⁻⁹, 10⁻¹⁰, 10⁻¹¹ or 10⁻¹² M. The affinity of an antibody for an antigen can be determined experimentally using any suitable method. Such methods may utilize Biacore or KinExA instrumentation, ELISA or competitive binding assays known to those skilled in the art.

ADR libraries can be used independently to affinity-mature any antibody or antibody fragment.

The antibody variable regions can be isolated and used to make full length antibodies, or any desired antigen binding fragment, and expressed in any host, including mammalian cells, insect cells, plant cells, yeast, and bacteria. Expression vectors and in vitro translation methods are well known. Mammalian cells include immortalized cell lines such as hybridomas or myeloma cell lines such as SP2/0 (American Type Culture Collection (ATCC), Manassas, Va., CRL-1581), NS0 (European Collection of Cell Cultures (ECACC), Salisbury, Wiltshire, UK, ECACC No. 85110503), FO (ATCC CRL-1646) and Ag653 (ATCC CRL-1580) murine cell lines. An exemplary human myeloma cell line is U266 (ATTC CRL-TIB-196). Other useful cell lines include those derived from Chinese Hamster Ovary (CHO) cells such as CHO-K1SV (Lonza Biologics), CHO-K1 (ATCC CRL-61) or DG44. Methods of making antibodies and purifying them are well known in the art.

### Methods of Affinity-Maturing Antibodies

Demand for high affinity antibodies has been increasing in the last years, in particular for antibodies with therapeutic value, where affinity could have a direct impact in dosage and hence in potential immunogenicity and production costs. A number of strategies to evolve the affinity of antibodies have been reported, including random (Groves et al., J. Immunol. Methods 313:129-39, 2006) and site-directed mutagenesis (SDM) methods (Barbas et al., Proc. Natl. Acad. Sci. USA 91:3809-13, 1994). In the former, changes are randomly introduced across the entire V gene and the best variants are selected using high throughput screening techniques such as phage, mRNA and ribosome display (Lipovsek and Pluckthun, J. Immunol. Methods 290:51-67, 2004). Site-directed mutagenesis methods (SDM), on the other hand, are designed to introduce mutations into predefined residues, with the potential advantage over random mutagenesis methods that one has more control over the consequences of the introduced changes.

Nonetheless, the general SDM method still faces the challenge of identifying which residues to target for randomization. When using molecular display techniques such as phage or ribosome display, only a limited set of residues can be randomized as the size of the libraries increases exponentially for every added residue. For instance, a library built on the common NNK diversification scheme, which introduces 32 codons in every position, grows by 32ⁿ for every n number of residues. Phage libraries built by restriction cloning and transformation are normally limited to a size of 10⁹-10¹⁰ members, which means that only 6-7 residues can be targeted if full sequence coverage is to be achieved in the library. Thus, methods to precisely identifying the key positions for randomization are highly sought after. The methods of the invention provide two affinity-maturation methods where predefined positions are targeted for substitution, e.g. the ADRs and the SDRU residues.

### Affinity-Maturation Using ADR Libraries

Another embodiment of the invention is a method of affinity-maturing an antibody, comprising the steps of
a. obtaining an amino acid sequence of the antibody;
b. determining affinity determining residues (ADR) in the antibody;
c. generating a library of amino acid sequences of the antibody by variegating at least one ADR residue;
d. expressing said library in a host or translating the library in vitro; and
e. selecting from said library one or more antibodies having an improved affinity to an antigen.

Any antibody can be affinity-matured using the method of the invention. For example, any non-human, for example rodent or monkey, human, chimeric, or humanized antibody can be used. At least one, two, three or more ADRs may be variegated. ADRs residing in either light or heavy chain may be variegated. Alternatively, a defined subset of ADRs can be variegated.

In another aspect of the invention, the ADR residues variegated are selected from Chothia residues 34H, 51H, and 55H;

In another aspect of the invention, the ADR residues variegated are selected from Chothia residues 34H, 51H, 55H, 59H, 60H, and 61H. ADR residues are determined as described above and shown in FIGS. 1 and 2. Methods of generating libraries, expressing and isolating antibodies and antibody fragments, and measuring antibody affinities are described above.

### Affinity-Maturation Using SDRU Libraries

Another embodiment of the invention is a method of affinity-maturing an antibody, comprising:
a. obtaining an amino acid sequence of the antibody;
b. determining specificity determining residue usage (SDRU) residues in the antibody;
c. generating a library of amino acid sequences of the antibody by variegating at least one SDRU residue;
d. expressing the library in a host or translating the library in vitro; and
e. selecting from the library one or more antibodies having an improved affinity to an antigen.

Any antibody can be affinity-matured using the method of the invention. For example, any non-human, for example rodent or monkey, human, chimeric, or humanized antibody can be used. At least one, two, three or more SDRU residues may be variegated. SDRU residues residing in either light or heavy chain may be variegated. Alternatively, a defined subset of SDRU residues can be variegated.

In another aspect of the invention, the SDRU residues variegated are selected from Chothia residues 91L, 92L and 93L.

In another aspect of the invention, the SDRU residues variegated are selected from Chothia residues H32, H50, H52, H53, H54, H56, and H58.

In another aspect of the invention, the SDRU residues variegated are selected from Chothia residues L30, L31, L32, L92, L93, L94, and L96.

Methods of generating libraries, expressing and isolating antibodies and antibody fragments, and measuring antibody affinity are described above. The methods of the invention can lead to significant improvement in antibody affinity. For example, anti-IL-13 antibody affinity was improved up to 25-fold, and anti-IL-17 affinity improved by 2-fold from parent antibodies, as is demonstrated in the examples below.

The present invention will now be described with reference to the following specific, non-limiting examples.

### Example 1

### Humanization of a Mouse Anti-CD147 Antibody Using SDRR

### Generation of a Mouse Anti-CD147 Antibody 4A5

Extracellular matrix metalloprotein (MMP) inducer (EMMPRIN), also known as basigin or CD147, is a 44-66 kDa, type I transmembrane protein that belongs to the immunoglobulin superfamily. Human CD147 amino acid sequence is shown in GenBank Acc No: BAB88938.1, SEQ ID NO: 1.

4A5 is a murine antibody generated using purified N-terminal human CD147 (amino acids 19-117 of SEQ ID NO: 1) as an antigen, with an A19N substitution. Cloning, expression, protein purification and immunizations were done using standard methods. The affinity of the 4A5 Fab for the CD147 His-tagged N-terminal domain was 120 nM, as measured by Surface Plasmon Resonance (SPR) (Table 3).

### SDRU Annotation

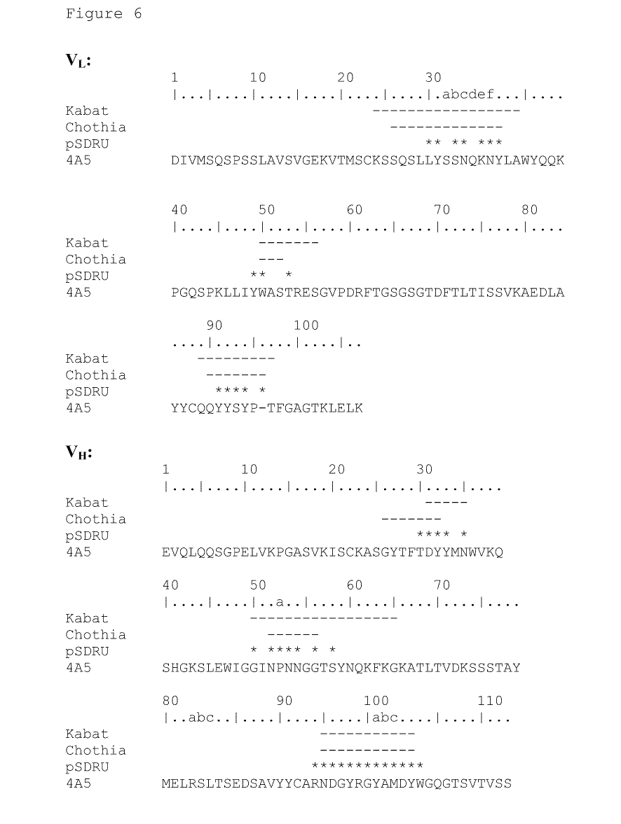

The amino acid sequence of the VL and VH domains of 4A5 was resolved and is shown in FIG. 6 (VH SEQ ID NO: 2; VL SEQ ID NO:3). On the top of the sequences, the CDR and HV definitions as determined in FIGS. 1 and 2 are provided. To determine SDRU residues, SDRU of anti-protein antibodies (pSDRU, Table 1) were utilized.

### Selection of a Human Germline Antibody Variable Region Gene Sequences

Analyses of variable region sequence of mAb 4A5 HV loop lengths and residues in positions defining the canonical structures indicated that 4A5 VL encoded for the canonical structure class 3-1 (for L1 and L2, respectively). In L3, 4A5 has a deletion, thus qualifying for a canonical structure type 5 (Table 3). Since no human germline gene has canonical structure type 5 at L3, L3 was not considered in the SDRU ranking. 4A5 VH encoded class 1-2 (for H1 and H2, respectively).

Comparison with the human germline repertoire (shown in FIGS. 3 and 4) identified 3 VL genes sharing the canonical structure class 3-1-1: 011, 01 and B3, and seven human VH genes with canonical structure class 1-2: 1-18, 1-69, 1-e, 1-f, 5-51, 5-a and 7-4.1. These germline gene sequences were selected for further ranking.

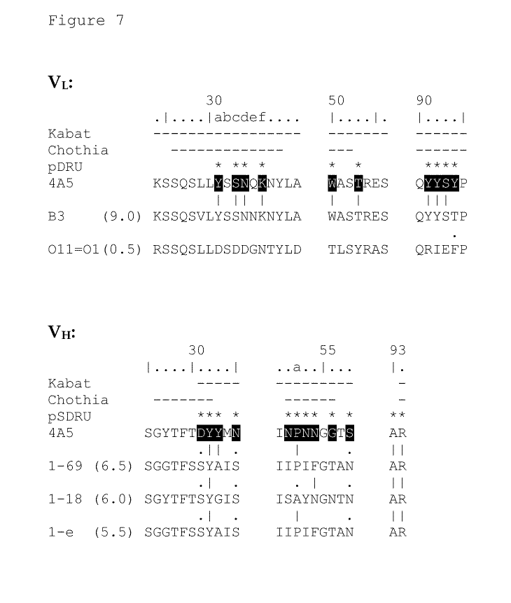

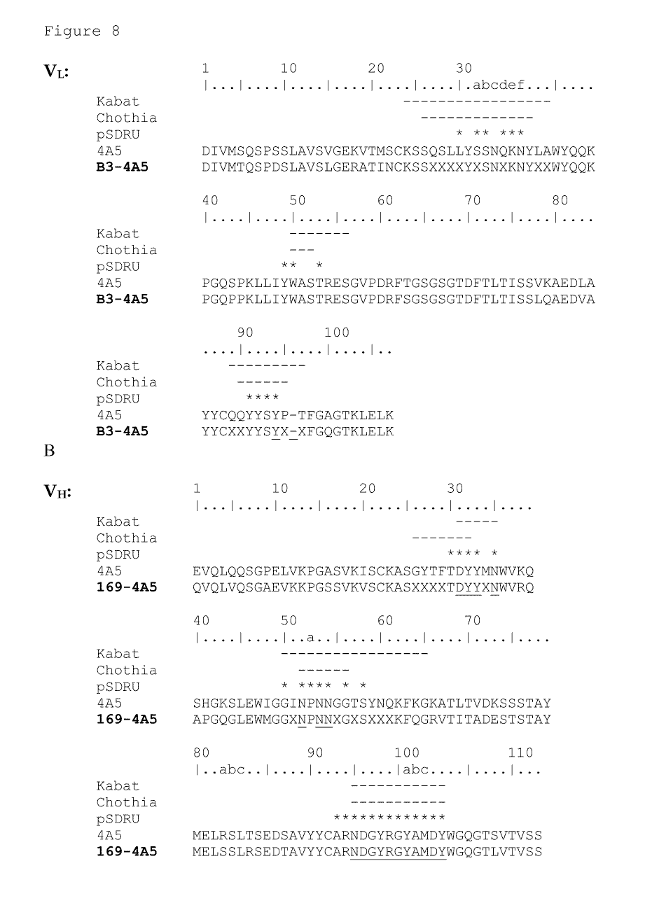

Calculation of the SDRU rank score between 4A5 and the human germline genes were conducted and shown in FIG. 7. For VL, human B3 was found to be more homologous to murine 4A5 with the SDRU rank score of 9.0 than human O11 and O1 sequences, which were identical and had only one similarity at position 94 and a rank score of 0.5 when compared to the sequence of 4A5. For VH, similar comparison identified 1-69 as the most homologous gene sequence to 4A5 wih a rank score of 6.5. The three human genes with the highest score were shown in the FIG. 7. Further inspection of the expression profile of 1-69/B3 according to de Wild (de Wildt et al., J. Mol. Biol. 285: 895-901, 1999) indicated that both genes were well expressed in vivo thus providing additional support for selection. Hence, 1-69/B3 was selected as VH/VL scaffold to substitute 4A5 SDRU residues. Sequence of 1-69 is shown in SEQ ID NO: 4, and the sequence of B3 is shown in SEQ ID NO: 5.

To identify a human germline J region as FR4 donor a sequence comparison with the IGkJ germline genes for the light chain and IGHJ germline genes for the heavy chain compiled at the ImMunoGeTics Database (http:_//www_imgt_org) was conducted. Sequences of the IGkJ and IGHJ are shown in FIG. 5. The highest rank score was obtained for the Jκ1 and JH4, respectively, which were selected as FR4 sequences.

### SDRU Resurfacing

The SDRU residues substituted into the selected heavy and light chain scaffolds from the anti-mouse antibody were residues 94L for CDR-L3, 31H, 33H and 35H for CDR-H1, 52H, 53H, 54H, 56H and 58H for CDR-H2, and residues 95H-102H for CDR-H3. Sequences of the humanized heavy and light chain variable regions are shown in SEQ ID NO: 6 and SEQ ID NO: 7, respectively.

The SDRR-humanized heavy and light chain variable regions were expressed as hybrid Fabs and tested by ELISA to assess the impact of the humanization process on VH and VL. Hybrid Fabs containing a SDRR-humanized VH (SEQ ID NO; 6) or VL (SEQ ID NO: 7) chain, the parent 4A5 VH (SEQ ID NO: 2) or VL (SEQ ID NO: 3) chain, or the selected scaffolds 1-69 (SEQ ID NO:4) or B3 (SEQ ID NO:5) were expressed and tested for binding to CD147. Results of binding of the generated Fabs are shown in Table 4. The SDRR-humanized VL demonstrated binding to CD147, whereas the SDRR-humanized VH showed undetectable binding.

TABLE 4
Binding of hybrid Fabs to CD147.

| Fab | VH (SEQ ID NO:) | VL (SEQ ID NO:) | CD147 binding |
|---|---|---|---|
| 1 | Mouse (2) | Mouse (3) | + |
| 2 | Humanized (6) | Humanized (7) | − |
| 3 | Humanized (6) | Mouse (3) | − |
| 4 | Mouse (2) | Humanized (7) | + |
| 5 | Mouse (2) | Germline gene (5) | − |

### Example 2

### Affinity-Maturation by Generating ADR Libraries

Based on binding experiments of the humanized and hybrid Fabs as described in Example 1, it was determined that VH played a more important role in 4A5/CD147 interaction than VL and the ADR library was limited to VH. ADR residues targeted for diversification were 26H, 27H, 28H, 29H and 34H for CDR-H1, and 51H, 55H, 57H, 59H, 60H, and 61H for CDR-H2. FIG. 8 shows the design of the ADR libraries and substituted SDRR residues for the 4A5 heavy and light chains.

### Library Generation and Screening

B3/4A5 variable region (SEQ ID NO: 7) was synthesized by assembling overlapping oligos using PCR method (Stemmer et al., Gene 164: 49-53, 1995) with two restriction cloning sites: Nhe I at 5′ and Rsr II at 3′ to be cloned as a Nhe I-Rsr II fragment into pCNTO-lacI-pIX (WO2009085462A1).

The ADR library for 1-69/4A5 was synthesized by overlapping PCR using oligos with NNK mix in the ADR positions using cDNA encoded by a variable region sequence shown in SEQ ID NO: 6 as a template. This way a sample of all possible variants in the ADR positions was obtained. The amino acid sequences encoded by the resulting library are shown in SEQ ID NO: 8.

Agarose gel extracted and purified PCR mixture was digested with Sfi I and Xho I and ligated into pCNTO-lacI-pIX vector containing B3-4A5. Ligated DNA was precipitated by adding 1 μl of 20 mg/ml glycogen, 500 μl n-butanol, vortexed, and spun at 10,000 rpm at RT 10 minutes. The supernatant was decanted and the pellet was washed in 1 ml of 70% EtOH, vortexed and spun at 4° C. 13,000 rpm for 10 minutes. Final pellet was resuspended in 20 μl of water after a 5-minute drying period. 10 μl of the ligation mixture was transformed into 50 μl MC1061F′ cells by electroporation and recovered in 1 ml of SOC for one hour at 37° C. Transformations were plated out on 100 μg/ml Carbincillin/1% Glucose plates to obtain single colonies, yielding a minimum of 10⁷ independent colonies per electroporation. Twenty electroporations yielded a library of 2×10⁸ transformants

Electroporated library was rescued in 400 μl SOC medium, after 1 hour incubation at 37° C. The culture was diluted into 1000 ml 2×YT with 100 μg/ml carbincillin containing 1% glucose, and shaken until OD600 reached 1.0. 100 ml of the culture was infected with VCSM13 helper phage (10¹¹/ml) (Stratagene) and the infected cells were centrifuged and resuspended into 500 ml 2×YT with Carbincillin, Kanamycin and 1 mM IPTG. The culture was shaken at 30° C. overnight. Phage supernatant was collected and the next day 10% PEG/NaCl was added. After incubating on ice for 2 hours, phage was centrifuged down at 10,000 rpm for 10 min and resuspended in 25 ml cold PBS and aliquated into 1 mL. Aliquots were stored at −70° C. until use.

The library was subjected to three rounds of panning. Specific phage were affinity selected by using human His-tagged N-terminal CD147 prepared as described above adsorbed on 96 well Maxisorp immunoplates (NUNC). After three rounds of selection, DNA was isolated from specific phage and pIX was removed by digesting with NheI/SpeI. Gel extracted and purified DNA without pIX was ligated transformed into 50 μl MC1061F′ cells by electroporation, and recovered in 1 ml of SOC for one hour at 37° C. Transformations were plated out on agar plates containing Carbencillin and Glucose to obtain single colonies for screening.

Single colonies were randomly picked to inoculate 100 μl/well of 2×YT containing Carbenicillin and 1% Glucose (2×YT/Carb) and grown overnight at 37° C. to make a master plate (MP). 20 μl of overnight culture from the MP was added to an expression plate (EP) containing 100 μl/well of 2×YT/Carbenicillin and grown for 6-8 hr at 37° C. shaking. Glycerol was added to the MP to a final of 20% and stored at −80° C.

After 6-8 hrs of growth, IPTG (1 mM) was added to the EP and incubated at 30° C. shaking overnight. ELISA plates were prepared by coating with 1 μg/ml human CD147 His-tagged N-terminal domain for binding and 1 μg/ml sheep anti-Fd (The Binding Site, Inc.) for expression. On the following day, the cells were lysed by adding 20 μl of 2.5 mg/ml Lysozyme in 1×PBS to each sample. Protein coated ELISA plates were washed with TBST and blocked by ChemiBlocker (Pierce). Plates were incubated with cell lysate for 1 h, washed with TBST buffer followed by anti-goat anti-human (Fab)-HRP conjugated antibody (Jackson Immunoresearch) incubation. Bound Fabs were detected by chemiluminescence method after HRP substrate addition.

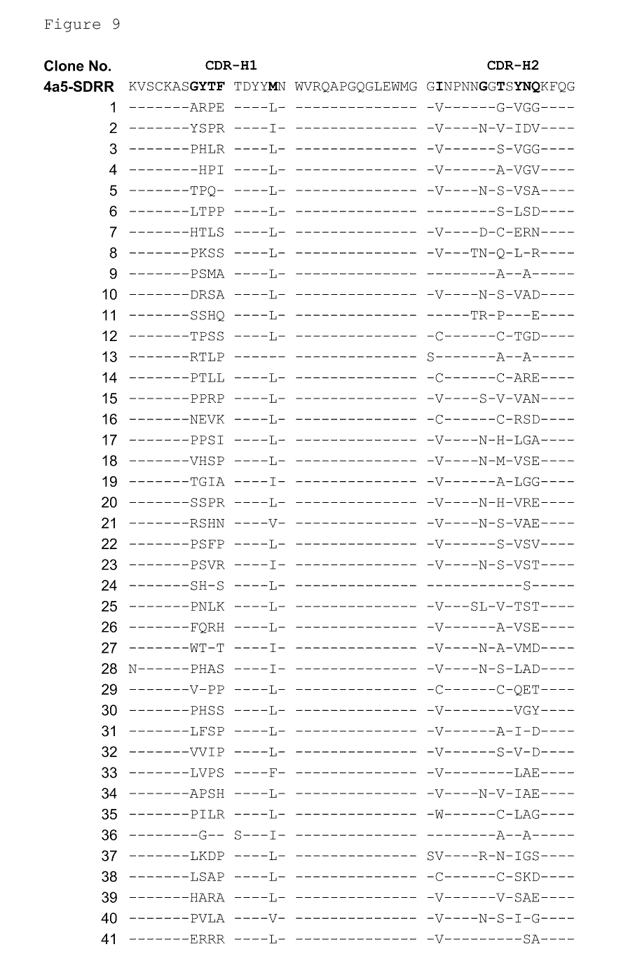

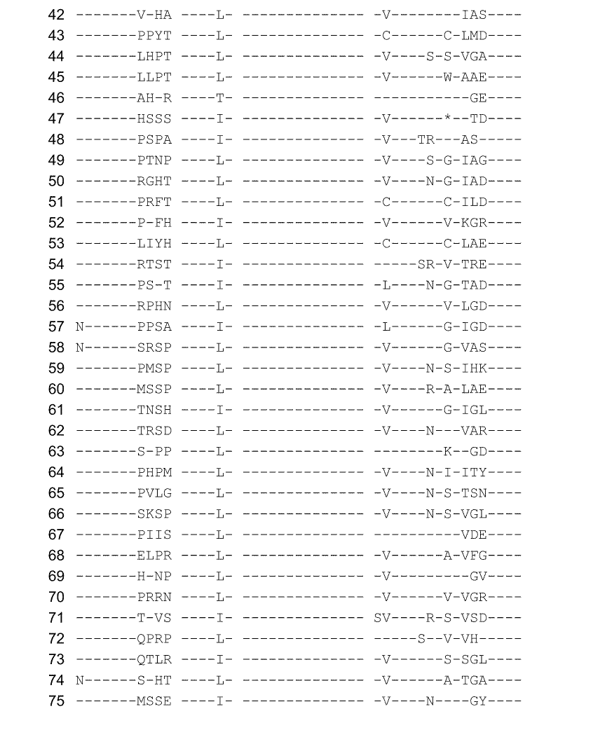

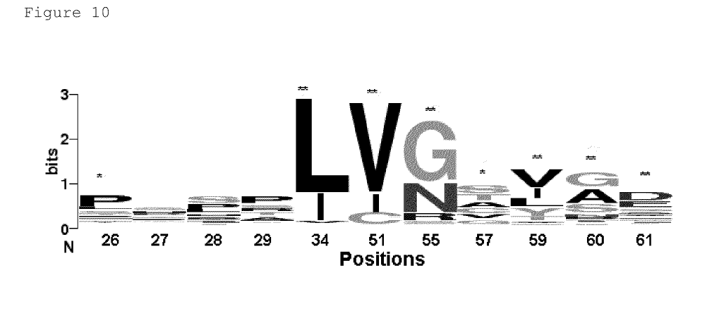

195 of 376 (53%) of the screened Fabs showed positive binding to CD147 in the ELISA format. Sequencing of 81 strong binders revealed 75 unique sequences, including two clones that appeared twice (FIG. 9). The distribution of amino acids in the ADRs is shown as a “logo” diagram (Schneider et al, Nucleic Acids Res. 18:6097-6100, 1990) (FIG. 10). In order to determine how ADR departed from amino acid frequencies generated by NNK codons, statistics analysis of these positions were carried out using a goodness-of-fit technique.

χ² values were calculated for each position. Positions showing a highly significant difference (p<0.01) in respect to the expected NNK frequencies were labeled with two asterisks. Positions with a significant frequency were labeled with one asterisk (p<0.05). As seen, ADR position 34H in H1 and positions 51H, 55H, 59H, 60H and 61H in H2 depart with highly significant differences from the NNK distribution, suggesting that these residues modify the loop conformations and/or relative positioning of CDR-H1 and CDR-H2. Positions 26 and 57 showed significant differences, suggesting that these positions may have an impact on affinity but are more tolerant to replacements.

### Characterization of Obtained Fabs

The generated Fab clones 70-75 of 4A5 shown in FIG. 9 were selected for further characterization. These Fabs had a VL having a sequence shown in SEQ ID NO: 7 and a VH having a sequence shown in SEQ ID NOs: 9, 10, 11, 12, 13, and 14 respectively). A single colony of each of the six clones was grown in 10 ml of 2×YT/Carbenicillin overnight. 1 L of fresh 2×YT/Carbenicillin was inoculated with the overnight culture and grown until OD 600 reached 0.8-1.0 O.D. Protein expression was induced with 1 mM IPTG and the culture was shaken overnight at 30° C. The 1 L culture was spun the next morning at 4500 rpm for 30 min. The supernatant was discarded and the pellet was resuspend in 100 ml 20 mM Tris, pH 8.5/350 mM NaCl/7.5 mM imidazole, plus 1 tablet of complete protease inhibitor (w/o EDTA). The homogenous cells were lysed with a microfluidizer (3×) and kept on ice. The microfluidized cells were centrifuged at 9 K rpm for 15 min. Supernatant was poured into clean tubes and then centrifugation was repeated.

Talon resin was equilibrated with 20 mM Tris pH 8.5/350 mM NaCl/7.5 mM Imidazole by spinning the Talon/EtOH at 2,000 rpm for 5 min, pouring off the EtOH, and resuspended in equal volumes of 20 mM Tris pH 8.5 repeating 2 times. 2 ml of this equilibrated Talon resin was added to each of the filtered supernatants. The mixture was incubated at room temperature while gently shaking for 2 hours. The His bound resin and supernatant were transferred to a 500 ml centrifuge bottle and spun at 4,500 rpm for 5 min. Most of the supernatant was poured off and about 30 mL was used to resuspend the talon pellet, which was loaded into a BioRad column. The resin was allowed to settle for about 5 min before the supernatant was removed by gravity flow. The resin was then washed 2 times with 50 mL of 20 mM Tris pH 8.5/350 mM NaCl/7.5 mM imidazole. The protein was eluted from the column with 150 mM EDTA/20 mM Tris; pH 8.5. The eluant was dialyzed in Tris, pH 8.5 overnight at 4° C.

Q-FF anion-exchange resin was equilibrated with 20 mM Tris, pH 8.5. To the dialyzed His-purified material 5-7.5 ml of the Q-FF anion exchange resin was added and incubated for 2 hr at RT shaking gently. The resin and supernatant were then loaded onto a column and the flow-through was collected and concentrated to about 1 mL. The concentration was determined by taking a 280 nm with a 320 nm subtraction reading from a Nanodrop uv/vis spectrophotometer. Concentration and purity was also determined by running purified samples on SDS-PAGE followed by staining the gel with Commassie Blue.

CD147 binding of the purified Fab samples side by side with 4A5 Fab was assessed by SPR. Using surface coupled human N-terminal CD147 (120 RU) affinities for 4A5 chimera and ADR Fab variants were calculated from the kinetics of Fab binding at increasing concentrations (11 to 600 nM). The affinities of the humanized affinity-matured Fabs ranged from 15 to 100 nM, while the chimeric 4A5 Fab displayed an affinity of 120 nM for human N-terminal CD147 domain (Table 3).

TABLE 3

| Clone | kₐ × 10⁵ M⁻¹s⁻¹ | k_{d} × 10⁻³ s⁻¹ | K_{D} (nM) |
|---|---|---|---|
| 4A5 | 1.9 | 11.06 | 120 |
| Clone 70 | 0.8 | 1.2 | 15 |
| Clone 71 | 0.818 | 2.38 | 30 |
| Clone 72 | 0.56 | 3.01 | 50 |
| Clone 73 | 0.45 | 3.97 | 90 |
| Clone 74 | 0.448 | 2.96 | 65 |
| Clone 75 | 0.444 | 4.25 | 10 |

### Epitope Mapping

To ensure that the epitope recognized by the affinity-matured variants was retained, epitope mapping was performed by assessing binding of 4A5 on human/mouse chimeric CD147 proteins. Human (BAB88938.1, SEQ ID NO: 1) and mouse (GenBank Acc. No. AAH10270.1, SEQ ID NO: 15) CD147 His-Tagged N-terminal domains and several human/mouse chimeric CD147 molecules were cloned into pCEP4 vector and expressed transiently in 293 cells using standard methods. The chimeric molecues expressed had amino acid sequences shown in SEQ ID NOs: 16, 17, 18, and 19, respectively. All humanized and affinity-matured Fabs exhibited a similar binding profile when compared to 4A5 and different from a non-specific Fab used as negative control. Thus, the epitope recognized by 4A5 in CD147 was retained after SDRR-humanization and subsequent affinity-maturation.

### Example 3

### Focused Affinity-Maturation by Introducing SDRU Diversity

### Affinity-Maturation of Anti-IL-13 Antibodies

The IL13-62 antibody chosen for affinity-maturation was a human framework adapted variant of IgG1 subtype of a parent mouse antibody secreted by a hybridoma C836. The framework sequences were from Hc2 and Lc6 heavy and light chain genes. The sequences of the heavy and light chain of IL13-62 are shown in SEQ ID NO: 20 and SEQ ID NO: 21, respectively.

The IL13-62 random phage library was created by variegating four anti-protein SDRU residues of high usage, residues H91, N92, E93, and Y94. The library was designed to introduce full diversity using NNK codons, providing a theoretical diversity of 1.9×10⁵ variants.

The Fab libraries were constructed in a pIX phage display system as described in U.S. Pat. No. 6,472,147 and WO2009085462A1. IL13-62 was expressed as a dicistronic unit containing the variable regions of Lc6 and Hc2. The libraries were assembled from three fragments by nested PCR using standard methods. The full-length fragments were cloned into the phage vector pCNTO-lacI-pIX.

The light chain CDR3 phage library was panned against biotinylated IL-13 having a R130Q substitution (Peprotech, Rocky Hill, N.J.) (IL-13 wild type amino acid sequence is shown in SEQ ID NO: 22). Briefly, previous to panning, paramagnetic beads (Invitrogen, Carlsbad, Calif.) coated with streptavidin were blocked in Chemiblocker (Chemicon, Temecula, Calif.). Similarly, the CDRL3 phage library was pre-blocked in Chemiblocker, diluted 1:1 in Tris buffered saline (TBS) with 0.05% Tween-20 (T) for 30 min at room temperature, followed by a pre-adsorption step, in which the CDRL3 library was incubated with the blocked magnetic beads to remove un-specific binders from the library. Biotinylated IL-13 variant R130Q was then added to the phage library in different concentrations (between 10 nM and 0.01 nM) for three successive rounds of panning. Antigen-bound phage was captured using magnetic beads and rescued by addition of 1 ml exponentially growing Escherichia coli TG-1 cells, OD(600 nm)=0.5, and incubation at 37° C. for 30 min. Phage was then produced and prepared for the next round of panning. Fab-pIX was produced from crude bacterial cell lysates of TG-1 colonies.

The quality of the CDRL3 library was assessed by sequencing 192 randomly picked clones. 178/192 had at least 80% sequence coverage (from NheI site to RsrII). 163/178 (92%) had no insertions and/or deletions (i.e. % usable clones) and all 163 clones were unique. The residue distribution was calculated from all the clones with sequence coverage using an in house program.

A high throughput single point (10 nM) ELISA was used to rank the obtained variants. Black Maxisorp plates (Nunc, Roskilde, Denmark) were coated overnight at 4° C. with 1 μg/ml of sheep anti-Fd antibody (binds CH1 domain of human IgG) in TBS. Plates were washed five times in TBST followed by blocking in 50% Chemiblocker/TBST for 1 h at RT. 50 μl of crude Fab-pIX cell lysates were added to each well and incubated for 1 hour at RT. Plates were washed and a dilution range of biotinylated IL13R130Q (Peprotech), diluted in 10% Chemiblocker/TBST, was added to the wells and incubated for 1 h at RT. In parallel plates, the capture of Fab was detected by adding HRP-conjugated Goat anti-Fab antibody (Jackson ImmunoResearch, West Grove, Pa.) at 1:5,000 dilution (in 10% Chemiblocker/TBST). The biotinylated IL-13R130Q was detected by Streptavidin-HRP at 1:5,000 dilution. Chemiluminescence substrate (POD, prepared according to the distributor's instructions, Roche) was added after a final wash and the plates were read in the Envision instrument (Perkin Elmer, Waltham, Mass.). Several variants showed higher chemiluminescence signal when compared to the used control Fabs, the parent murine IL13-62 Fab and IL13-167, the murine-human chimeric Fab.

The clones of interest, based on high binding signal in Fab-pIX format and sequence analysis, were converted to full IgG mAb format. The Fabs from the phage screen were digested with restriction enzymes and cloned into the CMV promoter vector, pUNDER, and sequence confirmed. The Lc6 variants were paired with Hc2 (SEQ ID NO: 20), or with a Hc2 having Methionine at positions 34 and 100 substituted for Glutamate, Serine, Valine, Glutamine or Leucine. The resultant Fabs were cloned in a vector containing a human IgG1, and purified using standard methods.

The affinities of select antibodies were determined by ELISA and Bioacore™, and are shown in Table 5. The affinity of the top 10 affinity-matured variants was in the 10 μM range or better.

### Affinity-Maturation of Anti-IL-17 Antibodies

IL-17 antibodies IL-17M70 and IL-17M82 chosen for affinity-maturation were human framework adapted variants of IgG1 subtype of a parent mouse antibody secreted by a hybridoma C1863A. The framework sequences were from Hc9 and Lc4 and Hc11 and Lc2 heavy and light chain genes for IL-17M70 and IL-17M82, respectively. The sequences of the heavy and light chain of IL-17M70 are shown in SEQ ID NO: 23 and SEQ ID NO: 24, respectively, and the sequences of the heavy and light chain of IL-17M82 are shown in SEQ ID NO: 25 and SEQ ID NO: 26, respectively. The affinities of the antibodies for human IL-17 were: 438 nM for IL-17M70 and 431 nM for IL-17M82, using Biacore. Methods used were essentially as described above for affinity-maturing the IL-13 antibody IL13-62.

The IL-17M70 and IL-17M82 libraries for phage maturation were constructed in pCNTO-Fab-pIX by randomizing protein SDRU residues (pSDRU in CDR-L1, CDR-L3, CDR-H1, and CDR-H2). Two libraries for each antibody were synthesized, one heavy chain library in CDR-H1 and CDR-H2 and one light chain library in CDR-L1 and CDR-L3. The residues randomized in the libraries were Chothia residues H32, H50, H52, H53, H54, H56, H58, L30, L31, L32, L92, L93, L94, and L96. The vectors for light chain libraries had the parent heavy chain sequence (Hc9 for IL-

TABLE 5

| | | | | | | | | ka | kd |
|---|---|---|---|---|---|---|---|---|---|
| | HC | | LC | | | | Affinity | (1/Ms) × | (1/s) × |
| Mab ID | M32 | M95 | H91 | N92 | E93 | Y94 | KD (pM) | 10E4 | 10−5 |
| M460 | | | | Del | D | | 8 | 103 | 0.8 |
| M480 | | | Q | Del | D | S | 21 | 186 | 3.9 |
| M463 | | | Q | D | L | G | 37 | 170 | 6.3 |
| M442 | | | Q | Del | D | G | 40 | 132 | 5.3 |
| M453 | | | | D | W | G | 44 | 106 | 4.7 |
| M447 | | | Q | D | I | G | 55 | 98 | 5.4 |
| M464 | | | | E | W | G | 55 | 129 | 7.1 |
| M450 | | | | D | P | G | 63 | 171 | 10.7 |
| M454 | | | Q | D | Y | G | 65 | 113 | 7.4 |
| M443 | | | | S | W | G | 88 | 88 | 7.8 |
| M449 | | | | E | S | G | 89 | 102 | 9.0 |
| M448 | | | | S | H | G | 92 | 139 | 12.7 |
| M468 | | | | F | W | G | 94 | 106 | 10.0 |
| M469 | | | | D | W | E | 100 | 143 | 14.3 |
| M167 | human/mouse chimera | | | | | | 135 | 238 | 32.0 |
| M456 | | | | S | Y | G | 148 | 124 | 18.2 |
| M451 | | | P | L | D | V | 177 | 188 | 33.3 |
| M444 | | | | V | W | G | 184 | 120 | 22.0 |
| M455 | | | | | | A | 186 | 163 | 30.3 |
| M475 | | | | L | M | G | 187 | 114 | 21.3 |
| M479 | | | P | L | D | T | 192 | 125 | 24.0 |
| M457 | | | | D | Y | A | 193 | 111 | 21.4 |
| M461 | | | | S | I | G | 193 | 133 | 25.7 |
| M478 | | | | | H | G | 208 | 119 | 24.7 |
| M466 | | | | D | W | S | 225 | 97 | 21.9 |
| M452 | | | | L | N | G | 233 | 116 | 27.0 |
| M470 | | | | L | D | S | 239 | 130 | 31.1 |
| M471 | | | P | I | D | A | 253 | 144 | 36.4 |
| M472 | | | P | L | D | S | 259 | 144 | 37.5 |
| M445 | | | | L | L | G | 262 | 111 | 29.1 |
| M482 | | | | L | D | S | 296 | 102 | 30.0 |
| M465 | | | | D | N | S | 306 | 110 | 33.6 |
| M473 | | | | D | R | D | 312 | 129 | 40.3 |
| M476 | | | | S | V | G | 315 | 102 | 32.1 |
| M446 | | | | V | G | G | 345 | 135 | 46.5 |
| M459 | | | P | L | | A | 356 | 126 | 44.9 |
| M474 | | | | D | L | G | 365 | 95 | 34.8 |
| M462 | | | | | F | G | 366 | 114 | 41.7 |
| M467 | | | | S | W | A | 452 | 100 | 45.5 |
| M477 | | | | S | S | G | 495 | 97 | 48.0 |
| H2L6 | HFS variant | | | | | | 754 | 125 | 94.4 |
| M1292 | E | L | | Del | D | | 8 | 105 | 0.8 |
| M1286 | S | L | | Del | D | | 9 | 128 | 1.2 |
| M1295 | V | L | | Del | D | | 15 | 120 | 1.8 |
| M1375 | Q | L | | Del | D | | 24 | 110 | 2.7 |
| M1268 | V | L | | | | | 621 | 161 | 100.0 |

17M70, SEQ ID NO: 23 and Hc11 for IL-17M82, SEQ ID NO: 25). Similarly, the vectors for heavy chain libraries had the parent light chain sequences (Lc4 for IL-17M70, SEQ ID NO: 24 and Lc2, for IL-17M82, SEQ ID NO: 26).

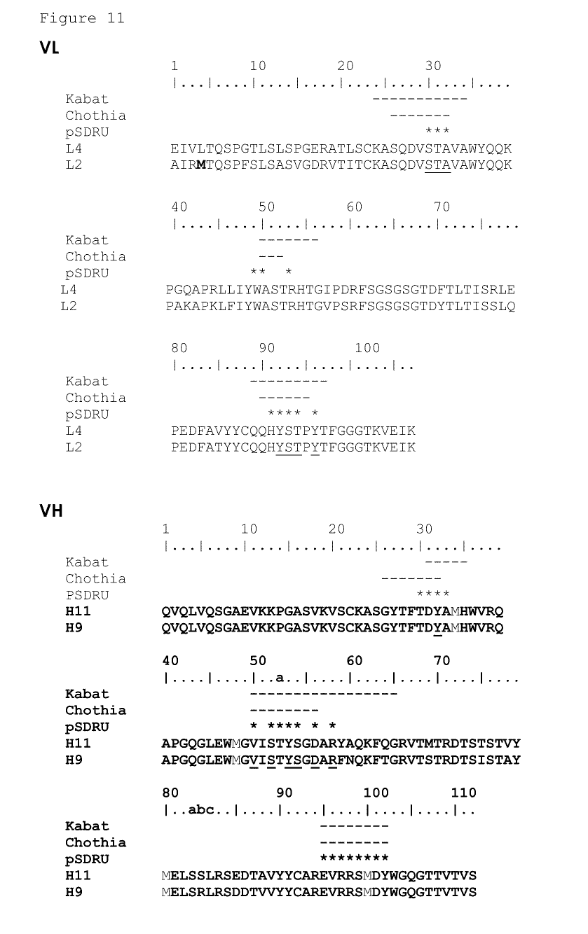

Sequences, pSDRU, Chothia and Kabat delineations of the light chains and heavy chains of IL-17M70 and IL-17M82 are shown in FIG. 11. The randomized residues in the libraries are underlined. Synthesis of the library was designed to introduce all amino acids in each position, except Methionine, Cysteine, Lysine, Glutamine and Glutamate. The theoretical diversity of the library was 2×10⁹ members. The pSDRU residues H30, H31, H50a and L91 were not randomized in order to limit the size of the library. The amino acid sequences encoded by the resulting libraries are shown in SEQ ID NO: 27 for IL-17M70 and in SEQ ID NO: 28 for IL-17M82 library.

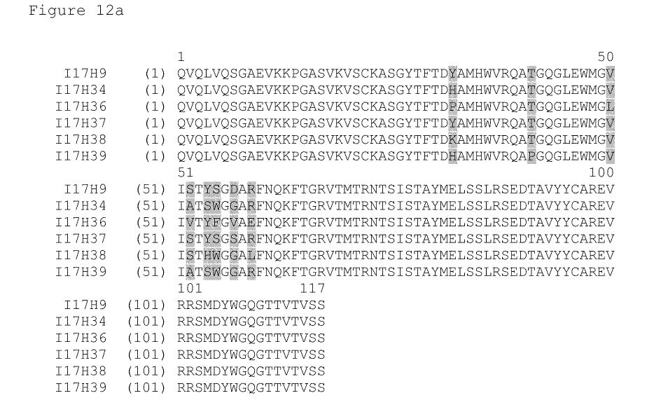

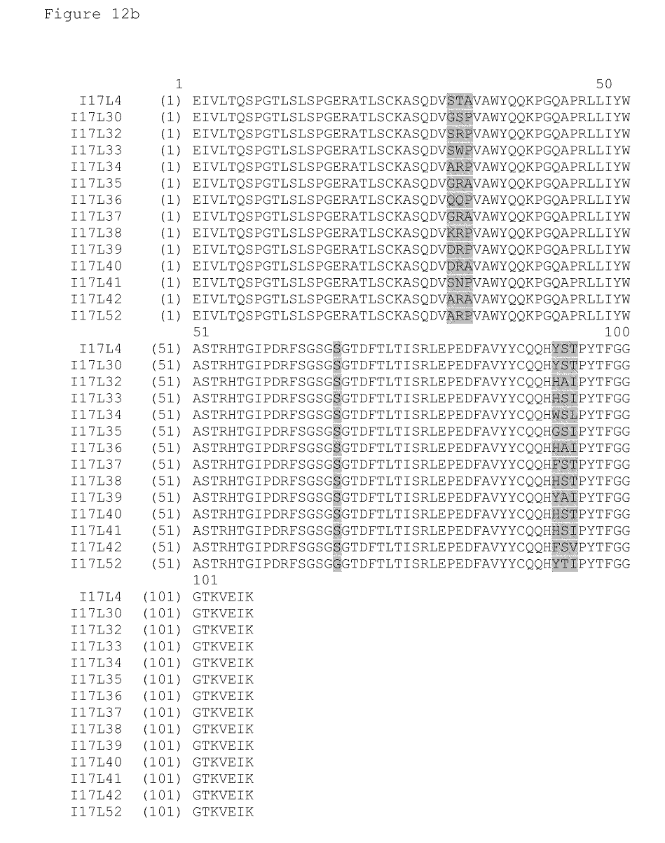

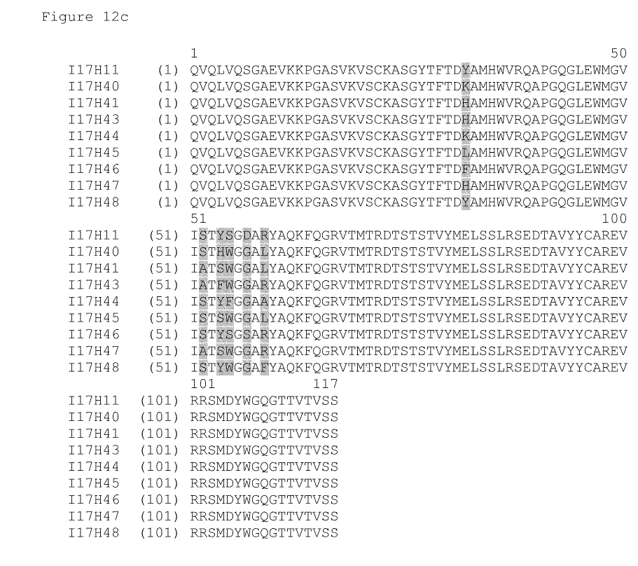

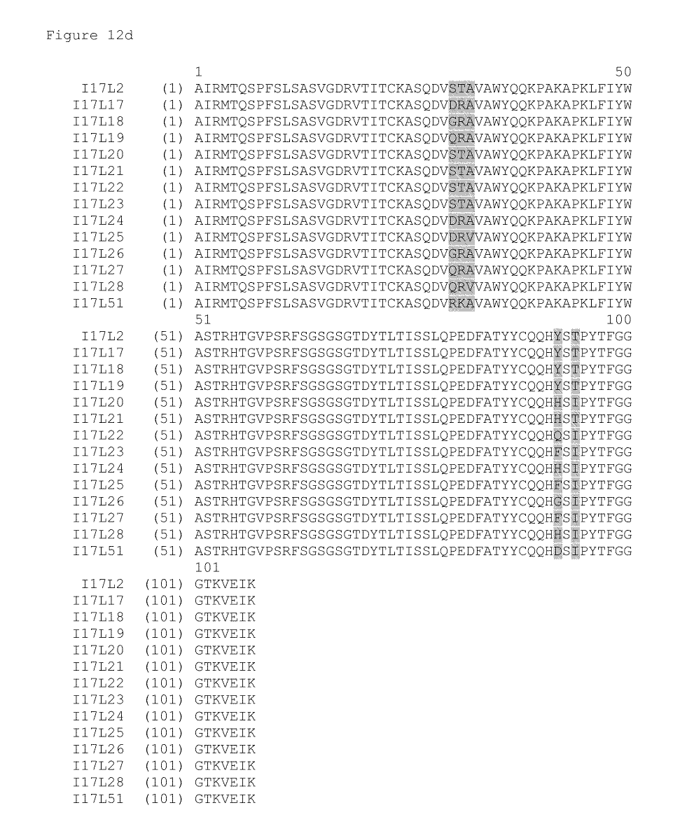

Phage preparation from the transformed library plates as well as panning was carried out as described above using biotinylated human IL-17A K3R/K74Q/A136Q variant (IL-17 wild type is shown in SEQ ID NO:29) at various concentrations between 10 nM and 0.01 nM. Colonies from the second and third round of panning were picked for production of Fab and sequencing. Based on Fab ELISA and sequence analysis, unique clones with binding signal better than the parent Fabs were identified. Total of 6 heavy and 14 light chains from the IL-17M70 library, and 9 heavy and 22 light chains from the IL-17M82 library were sequenced. Sequences of the heavy and light chain variants are shown in FIG. 12. The selected heavy and light chains were converted to mAbs and expressed in matrix transfections using standard protocols. % binding to human IL-17A variant (SEQ ID NO: 29) at 12 ng/ml was assessed for both IL-17M70 and IL-17M82 variant Fabs, and shown in Table 6 and 7, respectively. Four variant mAb of each parent were selected for further characterization (Table 8). The results or characterization are shown in Table 9. The affinity-matured mAbs had up to 2-fold improved affinity to IL-17 when compared to the parent antibody.

TABLE 6
% binding of IL-17M70 variant Fabs to IL-17

| | H34 | H36* | H37 | H38 | H39 | H9 |
|---|---|---|---|---|---|---|
| L30 | 207 | 0 | 185 | 320 | 139 | 0 |
| L32 | 171 | 0 | 166 | 89 | 118 | 193 |
| L33 | 182 | 0 | 154 | 122 | 207 | 190 |
| L34 | 149 | 0 | 124 | 66 | 113 | 116 |
| L35 | 88 | 0 | 150 | 52 | 145 | 225 |
| L36 | 143 | 0 | 156 | 124 | 216 | 162 |
| L37 | 174 | 0 | 158 | 102 | 155 | 220 |
| L38 | 144 | 0 | 163 | 123 | 101 | 128 |
| L39 | 188 | 0 | 215 | 89 | 199 | 240 |
| L4 | 148 | 0 | 168 | 106 | 149 | 100 |
| L40 | 123 | 0 | 216 | 132 | 161 | 149 |
| L41 | 200 | 0 | 211 | 164 | 247 | 239 |
| L42 | 98 | 0 | 141 | 152 | 141 | 149 |
| L62 | 160 | 0 | 140 | 92 | 166 | 189 |

*All matrix transfections with H36 resulted in complete loss of binding

TABLE 7
% binding of IL-17M82 variant Fabs to IL-17

| | H11 | H40 | H41 | H43 | H44 | H45 | H46 | H47 | H48 |
|---|---|---|---|---|---|---|---|---|---|
| L17 | 82 | 150 | 199 | 141 | 188 | 140 | 111 | 147 | 155 |
| L18 | 72 | 215 | 131 | 174 | 164 | 238 | 93 | 130 | 104 |
| L19 | 66 | 96 | 127 | 138 | 184 | 122 | 99 | 96 | 101 |
| L2 | 100 | 57 | 80 | 59 | 88 | 122 | 70 | 77 | 66 |
| L20 | 123 | 154 | 192 | 159 | 263 | 175 | 168 | 225 | 237 |
| L21 | 114 | 128 | 148 | 135 | 200 | 187 | 154 | 198 | 189 |
| L22 | 112 | 91 | 165 | 152 | 194 | 147 | 172 | 231 | 141 |
| L23 | 117 | 88 | 148 | 149 | 226 | 166 | 122 | 189 | 124 |
| L24 | 117 | 89 | 174 | 174 | 257 | 197 | 167 | 227 | 147 |
| L25 | 120 | 144 | 203 | 180 | 282 | 212 | 168 | 203 | 175 |
| L26 | 85 | 105 | 137 | 147 | 211 | 150 | 139 | 166 | 107 |
| L27 | 103 | 126 | 212 | 152 | 184 | 202 | 165 | 144 | 105 |
| L28 | 122 | 213 | 291 | 219 | 349 | 163 | 264 | 305 | 191 |
| L51 | 89 | 148 | 163 | 213 | 306 | 108 | 190 | 217 | 191 |

*All matrix transfection with L43, L44, L45, L46, L47, L48, L49, L50 resulted in complete loss of binding

TABLE 8
VH and VL chains of select mAbs

| mAb | LC | HC | mAb | LC | HC |
|---|---|---|---|---|---|
| M70 | L4 | H9 | M82 | L2 | H11 |
| M228 | L42 | H34 | M364 | L27 | H47 |
| M268 | L30 | H38 | M405 | L28 | H44 |
| M458 | L39 | H9 | M406 | L51 | H44 |
| M460 | L41 | H9 | M435 | L28 | H47 |

TABLE 9
Characterization of mAbs.

| | ka | kd | |
|---|---|---|---|
| Antibody clone | (1/Ms) × 10⁶ | (1/s) × 10⁻⁴ | KD (nM) |
| I17M70 | 1.27 | 5.55 | 0.438 |
| I17M228 | 1.14 | 5 | 0.443 |
| I17M268 | 1.84 | 4 | 0.216 |
| I17M458 | 1.47 | 3.6 | 0.247 |
| I17M460 | 1.24 | 3 | 0.239 |
| I17M82 | 0.89 | 3.85 | 0.431 |
| I17M364 | 0.94 | 4.3 | 0.457 |
| I17M405 | 1.06 | 5.4 | 0.507 |
| I17M406 | 1.61 | 4.4 | 0.274 |
| I17M435 | 0.85 | 3.5 | 0.412 |

The present invention now being fully described, it will be apparent to one of ordinary skill in the art that many changes and modifications can be made thereto without departing from the spirit or scope of the appended claims.

We claim:

1. A method of humanizing an antibody, comprising the steps of:
a. obtaining an amino acid sequence of a non-human antibody variable region;
b. determining a first canonical structure class of the non-human antibody variable region;
c. obtaining a first library of amino acid sequences of human antibody variable regions encoded by germline genes;
d. selecting a group of amino acid sequences from the first library, comprising the steps of:
i. determining a second canonical structure class and a SDRU rank score for each amino acid sequence in the first library; and
ii. identifying the group of amino acid sequences from the first library having the identical second canonical structure class with the first canonical structure class, and further having the highest SDRU rank score; and
e. substituting in the group of amino acid sequences selected in step d) SDRU residues with corresponding non-human SDRU residues to produce a humanized antibody.

2. The method of claim 1 wherein the germline genes are selected from VH, Vκ, Vλ, JH, Jκ, or Jλ sequences.

3. The method of claim 1 wherein the variable region is a heavy chain variable region or a light chain variable region.

4. The method of claim 1 wherein the humanized antibody is of IgG1, IgG2, IgG3, IgG4, IgM, IgD, IgE, or IgA type.

5. The method of claim 1, further comprising selecting the group of amino acid sequences from the library using one of the following selection criteria:
a. evaluating pairing of antibody variable regions; or
b. selecting the group of amino acid sequences from the first library having an identical canonical structure for at least one HV loop with the non-human antibody variable region when the first canonical structure class is not present in the group of amino acid sequences in the first library.

6. The method of claim 1, further comprising the steps of:
e-i: determining affinity determining residues (ADR) in the group of amino acid sequences selected in step d);
e-ii: generating a second library of amino acid sequences of human antibody variable regions by variegating at least one ADR residue;
e-iii: expressing the second library in a host or translating the second library in vitro; and
e-iv: selecting from the second library those variable regions having a desired biological activity.

7. The method of claim 6, wherein the at least one ADR residue is variegated.

8. The method of claim 6, wherein at least two ADR residues are variegated.

9. The method of claim 6, wherein at least three ADR residues are variegated.

10. The method of claim 6, wherein the at least one ADR residue variegated is selected from the ADR residues in the heavy chain.

11. The method of claim 6, wherein the at least one ADR residue variegated is selected from the ADR residues in the light chain.

12. The method of claim 6, wherein the at least one ADR residue variegated is selected from Chothia residues 34H, 51H, or 55H.

13. The method of claim 6, wherein the at least one ADR residue variegated is selected from Chothia residues 34H, 51H, 55H, 59H, 60H, or 61H.

14. The method of claim 6, wherein the ADR residues variegated are Chothia residues 34H, 51H, and 55H.

15. The method of claim 6, wherein the ADR residue variegated are Chothia residues 34H, 51H, 55H, 59H, 60H, and 61H.

16. The method of claim 6, wherein the ADR library is expressed as a Fv, scFv, dAb, or Fab antibody fragment.

17. The method of claim 6, wherein the ADR library is expressed as a fusion protein.

18. The method of claim 17, wherein the fusion protein is a phage coat protein.

19. The method of claim 18, wherein the coat protein is a phage pIX.

20. The method of claim 6, wherein the host is a mammalian cell, bacterium, or yeast.

21. A method of affinity-maturing an antibody, comprising the steps of:
a. obtaining an amino acid sequence of the antibody;
b. determining affinity determining residues (ADR) in the antibody;
c. generating a library of amino acid sequences of the antibody by variegating at least one ADR residue;
d. expressing the library in a host or translating the library in vitro; and
e. selecting from the library one or more antibodies having an improved affinity to an antigen.

22. The method of claim 21, wherein at least two ADR residues are variegated.

23. The method of claim 21, wherein at least three ADR residues are variegated.

24. The method of claim 21, wherein the at least one ADR residue variegated is selected from the ADR residues in the light chain.

25. The method of claim 21, wherein the at least one ADR residue variegated is selected from the ADR residues in the heavy chain.

26. The method of claim 21, wherein the at least one ADR residue variegated is selected from Chothia residues 34H, 51H, or 55H.

27. The method of claim 21, wherein the at least one ADR residue variegated is selected from Chothia residues 34H, 51H, 55H, 59H, 60H, or 61H.

28. The method of claim 21, wherein the ADR residues variegated are Chothia residues 34H, 51H, and 55H.

29. The method of claim 21, wherein the ADR residue variegated are Chothia residues 34H, 51H, 55H, 59H, 60H, and 61H.

30. The method of claim 21, wherein the antibody is a Fv, scFv, dAb, or Fab fragment.

31. The method of claim 21, wherein the library is expressed as a fusion protein or translated in vitro.

32. The method of claim 31, wherein the fusion protein is a phage coat protein.

33. The method of claim 32, wherein the coat protein is pIX.

34. The method of claim 21, wherein the host is a mammalian cell, bacteria, or yeast.

35. The method of claim 21, wherein the antibody is a humanized antibody.

36. The method of claim 21, wherein the humanized antibody is humanized according to a method of claim 1.

37. A method of making an affinity-matured antibody, comprising:
a. obtaining an amino acid sequence of the antibody;
b. determining specificity determining residue usage (SDRU) residues in the antibody;
c. generating a library of amino acid sequences of the antibody by variegating at least one SDRU residue;
d. expressing the library in a host or translating the library in vitro; and
e. selecting from the library one or more antibodies having an improved affinity to an antigen.

38. The method of claim 37, wherein at least two SDRU residues are variegated.

39. The method of claim 37, wherein at least three SDRU residues are variegated.

40. The method of claim 37, wherein the at least one SDRU residue variegated is selected from the SDRU residues in the light chain.

41. The method of claim 37, wherein the at least one SDRU residue variegated is selected from the SDRU residues in the heavy chain.

42. The method of claim 37 wherein the at least one SDRU residue is selected from Chothia residues 91L, 92L or 93L.

43. The method of claim 37 wherein the at least one SDRU residue is selected from Chothia residues 30L, 31L, 32L, 92L, 93L, 94L, or 96L.

44. The method of claim 37 wherein the at least one SDRU residue is selected from Chothia residues 32H, 50H, 52H, 53H, 54H, 56H, or 58H.

45. The method of claim 37, wherein the SDRU residues variegated are Chothia residues 91L, 92L and 93L.

46. The method of claim 37, wherein the SDRU residues variegated are Chothia residues 30L, 31L, 32L, 92L, 93L, 94L, and 96L.

47. The method of claim 37, wherein the ADR residue variegated are Chothia residues 34H, 51H, 55H, 57H, 59H, 60H, and 61H.

48. The method of claim 37, wherein the antibody is a Fv, scFv, dAb, or Fab fragment.

49. The method of claim 37, wherein the library is expressed as a fusion protein.

50. The method of claim 49, wherein the fusion protein is a phage coat protein.

51. The method of claim 50, wherein the coat protein is pIX.

52. The method of claim 37, wherein the host is a mammalian cell, bacteria, or yeast.

53. The method of claim 37 wherein the antibody is a humanized antibody.

54. The method of claim 37 wherein the humanized antibody is humanized according to a method of claim 1.
